(19) United States
(12) Patent Application Publication
(10) Pub. No.: US 2006/0055266 A1
(43) Pub. Date: Mar. 16, 2006

(54) Sintered ring magnet

(75) Inventors: Taizo Iwami, Tokyo (JP); Yoshikazu Ugai, Tokyo (JP); Yuji Nakahara, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/227,184

(22) Filed: Sep. 16, 2005

(30) Foreign Application Priority Data
Sep. 16, 2004 (JP) JP2004-269228

(51) Int. Cl. H02K 1/04; H02K 21/12; H02K 1/27

(52) U.S. Cl. 310/156.47; 310/156.46; 310/156.38; 310/43

(57) ABSTRACT

A sintered ring magnet (10) is produced through processes of magnetically orienting magnetic powder by applying a magnetic field, pressing the magnetic powder and sintering a ring-shaped powder compact (30) thus formed. The sintered ring magnet (10) has a generally cylindrical outer surface with surface corrugations formed by alternating hollows (11) and protrusions (12) at regular intervals around the sintered ring magnet (10) at least in part along an axial direction thereof, wherein the sintered ring magnet (10) varies in cross-sectional shape from one position to next along the axial direction, and magnetic poles are formed along the surface corrugations with boundaries of the magnetic poles located in the hollows (11). The hollows (11) and the protrusions (12) are skewed about a longitudinal axis of the sintered ring magnet (10). The surface corrugations are shaped into a wavy pattern expressed approximately by absolute values of a sine wave.

### BACKGROUND OF THE INVENTION

1. Field of the Invention

The present invention relates to the structure of a sintered ring magnet which is manufactured through a process of pressing magnetic powder in a magnetic field for producing a ring-shaped powder compact and a subsequent process of sintering the ring-shaped powder compact.

2. Description of the Background Art

Radially oriented ring magnets used in inner rotors of permanent magnet motors are often magnetized with a skew to form magnetic poles aligned at an oblique angle to an axial direction of the ring magnet for reducing fluctuations in rotating speed of the rotor due to cogging torque, for instance. However, a radially oriented ring magnet has a rectangular magnetization distribution pattern containing a great deal of distortion due to higher harmonic components and, therefore, it is difficult in many cases to sufficiently reduce the cogging torque by skewed magnetization alone.

A conventional approach to reducing the cogging torque is to form corrugations (protrusions and hollows) on a cylindrical outer surface of a ring magnet, the corrugations being skewed with respect to an axial direction of the ring magnet, as shown in Japanese Patent Application Publication Nos. 1997-35933 and 2001-211581. According to this approach, it is possible to reduce distortion of the magnetization distribution pattern along a rotating direction of the ring magnet by the corrugations as well as the cogging torque by the skewed corrugations.

More specifically, a cylindrical magnet shown in Japanese Patent Application Publication No. 1997-35933 is a one-piece magnet formed by binding magnetic powder with binder resin. While the inside diameter of this cylindrical magnet is same in all radial directions, the outside diameter of the same decreases at 90° intervals in a circumferential direction of the cylindrical magnet. This means that the cylindrical magnet of this Publication has thin wall portions (wall thickness changing portions) where the wall thickness decreases. These four thin wall portions are formed at regular angular intervals along the circumference. Since the thin wall portions are skewed by a specific angle with respect to the axial direction of the cylindrical magnet, locations of the thin wall portions continuously change along the axial direction.

On the other hand, Japanese Patent Application Publication No. 2001-211581 shows a structure of a magnet formed with binder resin for forming a magnetic field in a brushless direct current (DC) motor. Corrugations (protrusions and hollows) are formed on a generally cylindrical outer surface of the magnet along a circumferential direction thereof, the corrugations being skewed with respect to an axial direction of the magnet. The magnet is fitted in such a manner that the corrugated outer surface of the magnet faces a curved inner surface or a curved outer surface of a stator of the brushless DC motor.

The magnets shown in Publication Nos. 1997-35933 and 2001-211581 are so-called bonded magnets which are produced by molding magnetic powder with thermosetting resin or thermoplastic resin used as a binder. Generally, magnetic force produced by the bonded magnets is so weak that the bonded magnets can not be used for manufacturing compact high-power motors. For example, a bonded rare-earth magnet produces a maximum energy product of about 10 to 25 MGOe which is low compared to an energy product of 40 MGOe produced by a typical sintered neodymium-ion-boron magnet. Since the magnetic force produced by the bonded magnets is so weak that the bonded magnets are not applicable to manufacturing servomotors which require a strong magnetic force.

The magnet shown in Publication No. 1997-35933 is a resin-molded magnet which must be formed by using a specialized extruder. This extrusion molding process has a problem that the magnetic force of the resin-molded magnet which is weak by nature becomes still weaker because it is impossible to increase the magnetic force by applying a magnetic field during the molding process for anisotropically magnetizing the magnet.

Additionally, resin-molded magnets manufactured by the extruder are limited to shapes in which magnetic poles are obliquely formed, or skewed, with respect to an axial direction of the magnet. In a ring magnet used in a motor, however, magnetic properties of the magnet are not necessarily uniform along the axial direction, the ability of a magnetic circuit to conduct magnetic flux from the ring magnet to a stator, or permeance, varies along the axial direction, and saturation status of the stator varies along the axial direction. To cope with these problems, it is necessary to vary the shape of the magnet along the axial direction.

On the other hand, manufacture of sintered rare-earth magnets requires a process of pressing pulverized magnetic material (magnetic powder) by use of a pressing machine (a pressing machine for pressing the magnetic powder in a magnetic field) followed by a sintering process. Generally, this manufacturing method is associated with a problem of poor magnet shape accuracy.

### SUMMARY OF THE INVENTION

The invention is intended to provide a solution to the aforementioned problems of the prior art. Specifically, it is an object of the invention to provide a sintered ring magnet capable of producing a powerful magnetic force, in which corrugations (protrusions and hollows) are formed on a generally cylindrical outer surface of the ring magnet, the corrugations being skewed with respect to an axial direction of the ring magnet, to reduce distortion of magnetization distribution along a circumferential direction of the ring magnet as well as cogging torque.

It is another object of the invention to provide a sintered ring magnet capable of reducing cogging torque even if magnet shape accuracy is not so high after a sintering process in manufacturing the ring magnet.

It is still another object of the invention to provide a sintered ring magnet for use in a motor, in which variations in magnetic properties, permeance of a magnetic circuit formed in the motor and saturation status of a motor stator are compensated by the shape of the ring magnet varied along an axial direction thereof to reduce torque fluctuations, such as cogging torque and torque ripple, caused by the aforementioned variations.

According to the invention, a sintered ring magnet is produced through processes of magnetically orienting magnetic powder by applying a magnetic field, pressing the magnetic powder and sintering a ring-shaped powder compact thus formed. The sintered ring magnet has a generally cylindrical outer surface with surface corrugations formed by alternating hollows and protrusions at regular intervals around the sintered ring magnet at least in part along an axial direction thereof, wherein the sintered ring magnet varies in cross-sectional shape from one position to next along the axial direction, and magnetic poles are formed along the surface corrugations with boundaries of the magnetic poles located in the hollows.

A typical example of the sintered ring magnet of which cross-sectional shape varies from one position to next along the axial direction is configured such that the hollows and the protrusions are skewed about a longitudinal axis of the sintered ring magnet.

Another typical example of the sintered ring magnet of which cross-sectional shape varies from one position to next along the axial direction is configured such that each of the hollows varies in cross-sectional shape from one position to next along the axial direction of the sintered ring magnet, the width or depth of each of the hollows continuously varying along the axial direction of the sintered ring magnet.

The sintered ring magnet thus structured can produce a well-controlled magnetomotive force distribution with high accuracy and with reduced variations in the amount of magnetic flux in the axial direction of the sintered ring magnet, for example. When installed in a motor, the sintered ring magnet can reduce torque fluctuations, such as cogging torque. Therefore, the sintered ring magnet of the invention serves to increase the amount of effectively working magnetic flux and torque generated by the motor, decrease the amount of exciting current and improve motor efficiency as a result of a reduction in copper loss. Consequently, the sintered ring magnet of the invention can be used for producing a high-power motor.

These and other objects, features and advantages of the invention will become more apparent upon reading the following detailed description along with the accompanying drawings.

### BRIEF DESCRIPTION OF THE DRAWINGS

FIG. 1 is a perspective view of a sintered ring magnet according to a first embodiment of the invention;

FIG. 2 is a perspective view of a sintered ring magnet according to a third embodiment of the invention;

FIG. 3 is a perspective view of the sintered ring magnet according to the third embodiment of the invention showing in particular an example of how magnetic poles are formed;

FIGS. 4A-4D are diagrams showing wall thicknesses and magnetomotive force distributions of an ordinary ring magnet with no hollows or protrusions formed on a cylindrical outer surface thereof and the ring magnet of the third embodiment with parallel hollows and protrusions formed on a generally cylindrical outer surface thereof;

FIG. 5 is a diagram showing a relationship between the changing wall thickness and angular position along the rotating direction of the ring magnet of the third embodiment for explaining in particular how an outer surface of each protrusion is machined to form part of the outer surface of the ring magnet of the third embodiment;

FIGS. 6A and 6B are diagrams showing paths of magnetic fluxes formed at one of the hollows in the outer surface of the ring magnet of the third embodiment;

FIG. 7 is a fragmentary plan view of a sintered ring magnet having rounded corners formed along boundaries of individual protrusions on a generally cylindrical outer surface of the ring magnet according to a fourth embodiment of the invention;

FIG. 8 is a perspective view of a sintered ring magnet according to a fifth embodiment of the invention;

FIGS. 9A and 9B are diagrams showing cross-sectional shapes of the sintered ring magnet of the fifth embodiment taken by planes perpendicular to a central axis thereof;

FIGS. 10A-10E are diagrams showing how the wall thickness of the ring magnet of the fifth embodiment varies in a rotating direction from one position to next along an axial direction of the ring magnet;

FIG. 11 is a diagram showing how average magnet wall thickness varies along the axial direction of the ring magnet of FIGS. 10A-10E;

FIG. 12 is a diagram showing a magnetomotive force distribution pattern of the ring magnet of FIGS. 10A-10E plotted along the rotating direction thereof;

FIG. 13 is a diagram showing an example of wall thickness distribution of a ring magnet;

FIG. 14 is a perspective view of a sintered ring magnet in one modified form of the fifth embodiment of the invention;

FIG. 15 is a perspective view of a sintered ring magnet according to a sixth embodiment of the invention;

FIG. 16 is a perspective view of the sintered ring magnet according to the sixth embodiment of the invention showing in particular an example of how magnetic poles are formed;

FIG. 17 is a perspective view of a sintered ring magnet in one modified form of the sixth embodiment of the invention;

FIG. 18 is a perspective view of a sintered ring magnet according to a seventh embodiment of the invention;

FIG. 19 is a perspective view of a sintered ring magnet in one modified form of the seventh embodiment of the invention;

FIG. 20 is a perspective view of a sintered ring magnet according to an eighth embodiment of the invention;

FIG. 22 is a perspective view of a sintered ring magnet in one modified form of the eighth embodiment of the invention;

FIG. 23 is a perspective view of a sintered ring magnet according to a ninth embodiment of the invention;

FIG. 24 is a perspective view of a sintered ring magnet in one modified form of the ninth embodiment of the invention;

FIG. 25 is a perspective view showing the sintered ring magnet of FIG. 24 as it is firmly fitted on a shaft;

FIG. 26 is a cross-sectional view of a motor formed by assembling the sintered ring magnet fitted on the shaft with a stator;

FIG. 27 is a perspective view of a sintered ring magnet according to a tenth embodiment of the invention;

FIG. 28 is a perspective view of a sintered ring magnet according to an eleventh embodiment of the invention;

FIGS. 29A-29F are diagrams schematically showing a pressing process for making a ring-shaped powder compact according to a first method of manufacturing a sintered ring magnet;

FIGS. 30A-30F are diagrams schematically showing a generally known pressing process for making a ring-shaped powder compact of a conventional radially-oriented ring magnet;

FIG. 31 is a diagram schematically showing a radially orienting magnetic field;

FIG. 32 is a perspective view showing an example of a ring-shaped powder compact produced by the first method of manufacturing a sintered ring magnet;

FIG. 33 is a perspective view of a die used in a ring magnet pressing unit in the first method of manufacturing the sintered ring magnet;

FIGS. 34A and 34B are perspective views of a die used in a ring magnet pressing unit in a second method of manufacturing a sintered ring magnet;

FIG. 35 is a perspective view showing a status of the ring magnet pressing unit during execution of a ring-shaped powder compact pressing process according to the second method;

FIG. 36 is a perspective view showing a status of the ring magnet pressing unit during execution of the ring-shaped powder compact pressing process according to the second method;

FIG. 37 is a perspective view showing a status of the ring magnet pressing unit during execution of the ring-shaped powder compact pressing process according to the second method;

FIG. 38 is a perspective view showing a status of the ring magnet pressing unit during execution of the ring-shaped powder compact pressing process according to the second method;

FIG. 39 is a perspective view showing a status of the ring magnet pressing unit during execution of the ring-shaped powder compact pressing process according to the second method; and

FIG. 40 is a perspective view of a sintered ring magnet in another modified form of the seventh embodiment of the invention.

### DETAILED DESCRIPTION OF THE PREFERRED EMBODIMENTS OF THE INVENTION

The invention is now described in detail with reference to preferred embodiments and specific examples thereof illustrated in the accompanying drawings.

### First Embodiment

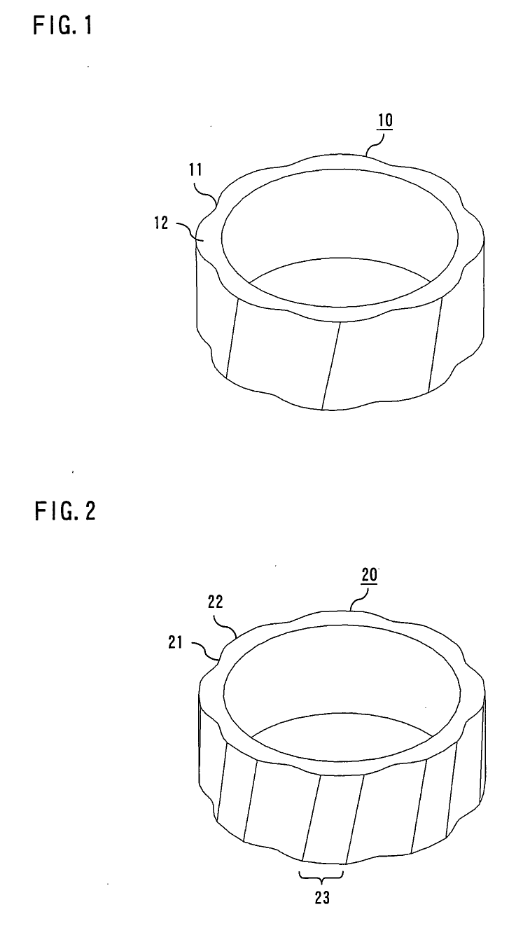

FIG. 1 is a perspective view of a sintered ring magnet 10 having a ring shape according to a first embodiment of the invention. The sintered ring magnet 10 is a magnet containing neodymium (Nd), iron (Fe) and boron (B) as main components. A generally cylindrical outer surface of the sintered ring magnet 10 is corrugated with alternating hollows 11 and protrusions 12 formed along the sintered ring magnet 10. The hollows 11 and the protrusions 12 are formed at regular intervals around the generally cylindrical outer surface of the sintered ring magnet 10. In the example shown in FIG. 1, the sintered ring magnet 10 has eight each hollows 11 and protrusions 12 alternately formed at specific angular intervals (45°).

The hollows 11 and the protrusions 12 are formed in parallel lines skewed by a specific inclination angle (skew angle) with respect to an axial direction of the sintered ring magnet 10. Magnetic poles of the sintered ring magnet 10 are formed by skewed magnetization so that the magnetic poles are aligned parallel to the hollows 11 and the protrusions 12 at the same skew angle with respect to the axial direction of the sintered ring magnet 10. Boundaries of these magnetic poles (eight poles in the sintered ring magnet 10 of FIG. 1) are located in the hollows 11.

Now, chemical makeup and manufacture of the sintered ring magnet 10 are explained. The sintered ring magnet 10 of this embodiment contains 30% by weight of neodymium (Nd), 1% by weight of boron (B), 3% by weight of dysprosium (Dy) and a remaining percentage of iron (Fe). Raw alloy mixed by a high-frequency melting process is subjected to a hydrogen embrittlement treatment and pulverized by a jet mill to produce magnetic powder having an average particle size of about 4 micrometers. This powder is pressed to form a ring-shaped powder compact having the aforementioned protrusions 12 and hollows 11 on the generally cylindrical outer surface while applying a magnetic field to the powder to align magnetic crystals in desired directions. Subsequently, the ring-shaped powder compact is subjected to sintering and heat treatment processes in vacuum at temperatures of 1,080° C., 900° C. and 600° C. to obtain a sintered ring-shaped powder compact shaped as illustrated in FIG. 1. It is to be noted that, to magnetically orient the ring-shaped powder compact, the powder may be compressed while applying the magnetic field or after applying the magnetic field in actual manufacturing.

The aforementioned corrugated structure of the sintered ring magnet 10 is described below in further detail. Preferably, an outer periphery of a cross section of the ring magnet 10 perpendicular to an axis thereof is shaped such that the thickness of the ring shape varies in a wavy pattern generally expressed by absolute values of a sine wave (or in a pattern of full-wave rectification of a sine wave) along a rotating direction (circumferential direction) of the ring magnet 10. Specifically, the sintered ring magnet 10 has a maximum wall thickness of 3 mm (at the protrusions 12), a minimum wall thickness of 1.8 mm (at the hollows 11), an axial length of 14 mm and a maximum outside diameter of 30 mm. Since the sintered ring magnet 10 of the embodiment is an 8-pole ring magnet, the wall thickness of the ring magnet 10 varies in a sinusoidal pattern four times along the circumference of the ring shape. Corrugations (the hollows 11 and the protrusions 12) of the ring magnet 10 are skewed by 15° along the axial length of 14 mm. This skew angle corresponds to an electrical angle of 60°.

The inventors have manufactured a motor by combining the sintered ring magnet 10 of the embodiment with a 12-slot stator and measured cogging torque. Measurement results indicate that the cogging torque is reduced by half or less in the motor using the sintered ring magnet 10 of the embodiment compared to a motor employing a conventional ring magnet having no corrugations.

Since the sintered ring magnet 10 of the present embodiment is a sintered neodymium-ion-boron ring magnet as mentioned above, the ring magnet 10 produces a strong magnetic force and the motor using this ring magnet 10 delivers a high output power. Additionally, the ring magnet 10 of the embodiment can produce a magnetomotive force distribution nearly the same as a sine wave and reduce harmonic distortion. When the sintered ring magnet 10 is assembled into a motor, harmonic distortion components of the magnetomotive force become a causal factor of torque fluctuations which result in cogging torque. Hence, it is possible to reduce the cogging torque by reducing the harmonic distortion components. Furthermore, as the magnetic poles are obliquely formed along the corrugations on the generally cylindrical outer surface of the ring magnet 10, it is possible to manufacture motors with a reduced cogging torque.

In the sintered ring magnet 10 of the embodiment, inter-pole regions, or boundaries between adjacent N- and S-poles, are located in the hollows 11. Strong magnetic fields produced by a stator tend to be applied to these inter-pole regions. As the magnetic fields produced by the stator are oppositely directed to magnetic fields produced by the ring magnet 10, the ring magnet 10 is likely to be demagnetized by the magnetic fields applied by the stator. Since the ring magnet 10 is recessed due to the provision of the hollows 11 in the inter-pole regions where demagnetization is most likely to occur, the ring magnet 10 of the embodiment produces such an advantageous effect that changes in magnet properties caused by demagnetization are reduced.

While the foregoing discussion of the first embodiment has illustrated the sintered ring magnet 10 containing neodymium, boron, dysprosium and iron, by way of example, other elements, such as cobalt (Co), aluminum (Al) and copper (Cu), may be added to the composition of the raw alloy. Also, the wall thickness of the ring magnet 10 may be varied by a larger degree than stated above within a range permissible from the viewpoint of mechanical strength of the ring magnet 10. While the wall thickness of the ring magnet 10 is varied in the wavy pattern generally expressed by the absolute values of a sine wave in the foregoing discussion, the same advantageous effect as mentioned above can be obtained by forming hollows according to a repetitive function or a quadratic function.

Furthermore, while a large cogging torque reduction effect is typically obtained with a skew angle corresponding to an electrical angle ranging from 60° to 70° and in the vicinity of this range, the cogging torque reduction effect may be obtained with a skew angle corresponding to an electrical angle out of this range depending on motor size. Additionally, specific components of the cogging torque can be reduced by changing the skew angle.

### Second Embodiment

A sintered ring magnet according to a second embodiment of the invention is also a ring-shaped sintered magnet containing neodymium, iron and boron as main components and having corrugations (protrusions and hollows) formed on a generally cylindrical outer surface like the sintered ring magnet 10 of the first embodiment. The protrusions and the hollows are formed in parallel lines skewed by a specific inclination angle (skew angle) about a longitudinal axis of the ring magnet. Magnetic poles of the ring magnet are formed along the corrugations with boundaries between the adjacent magnetic poles located in the individual hollows. What is characteristic of the sintered ring magnet of this embodiment is that each of the protrusions formed on the generally cylindrical outer surface of the ring magnet constitutes part of an imaginary cylindrical shape which defines an outermost surface of the ring magnet. Thus, as viewed along the longitudinal axis (central axis) of the ring magnet, each of the protrusions forms part of a circle (or an arc segment in cross section) of which center lies on a central axis of a cylindrical inner surface of the ring magnet, or on a rotational axis of the ring magnet.

Like the sintered ring magnet 10 of the first embodiment, the sintered ring magnet of the second embodiment is produced by a powder sintering method in which magnetic powder is pressed with a magnetic field applied to the powder and a ring-shaped powder compact thus formed is subjected to sintering and heat treatment processes. In the powder sintering method, a distortion of the shape of the ring magnet after sintering may occur if there are irregularities in the density of the pressed ring-shaped powder compact or if the ring-shaped powder compact is not uniformly magnetized in desired directions. If such a distortion of the ring shape occurs, the distance from the central axis of the ring magnet to the outermost surface thereof would vary from one protrusion to next formed on the generally cylindrical outer surface of the ring magnet. This variation in the distance from the central axis of the cylindrical inner surface of the ring magnet to the outermost surface thereof (or outer surfaces of the protrusions) is reduced by grinding or electric discharge machining those protrusions of which outer surfaces are distant from the longitudinal axis of the ring magnet so that the outer surfaces of the individual protrusions fit in the aforementioned imaginary cylindrical shape centered on the rotational axis of the ring magnet.

When the sintered ring magnet of the second embodiment is attached to a shaft and assembled into a motor together with a stator, the outermost surface of the ring magnet (i.e., the outer surface of each protrusion) aligns with the aforementioned imaginary cylindrical shape of the ring magnet centered on a rotational axis of the shaft. Therefore, the distance between the ring magnet and the stator is smallest at gaps between the outermost surface of the ring magnet (or the outer surfaces of the protrusions) and a cylindrical inner surface of the stator. The distance between the ring magnet and the stator can be reduced by making the gaps between the outermost surface of the ring magnet and the cylindrical inner surface of the stator as narrow as possible. Since the gaps between the magnet and the stator work as reluctance, or resistance to magnetic flux, it is possible to increase the amount of magnetic flux passing from the ring magnet into the stator. In the motor using the ring magnet of this embodiment discussed above, the gap between the outer surface of each protrusion and the cylindrical inner surface of the stator is typically set to approximately 0.5 mm. Consequently, the motor can produce a high torque and an increased output power. Also, as the motor can produce a desired torque with a reduced amount of exciting current, it is possible to decrease copper loss and thereby improve motor efficiency.

The aforementioned advantages of the present embodiment is achievable even if all of the protrusions formed on the generally cylindrical outer surface of the ring magnet do not constitute part of the imaginary cylindrical shape defining the outermost surface of the ring magnet. This means that it is not absolutely necessary to machine all of the protrusions if the protrusions most protruding outward are properly machined. Although the central axis of the imaginary cylindrical shape defining the outermost surface of the aforementioned ring magnet of the second embodiment coincides with the central axis of the cylindrical inner surface of the ring magnet, it is only necessary that the former coincide with the rotational axis of the motor shaft.

### Third Embodiment

FIG. 2 is a perspective view of a sintered ring magnet 20 according to a third embodiment of the invention. The sintered ring magnet 20 of this embodiment is a sintered magnet containing neodymium, iron and boron as main components like the sintered ring magnet 10 of the first embodiment. A generally cylindrical outer surface of the sintered ring magnet 20 is corrugated with alternating hollows 21 and protrusions 22 formed along the sintered ring magnet 20. The hollows 21 and the protrusions 22 are formed in parallel lines skewed by a specific inclination angle (skew angle) with respect to an axial direction of the sintered ring magnet 20.

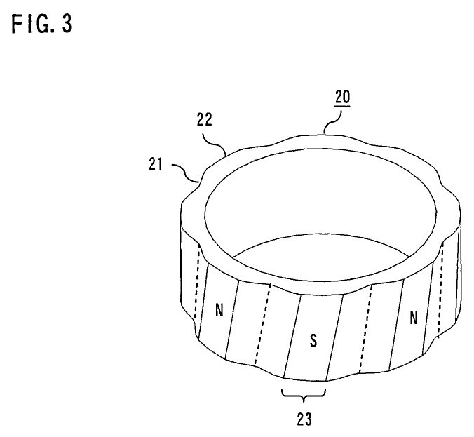

As shown in FIG. 3, magnetic poles of the sintered ring magnet 20 are formed such that the magnetic poles are aligned parallel to the hollows 21 and the protrusions 22 at the same skew angle with respect to the axial direction of the sintered ring magnet 20. Boundaries of these magnetic poles (shown by broken lines in FIG. 2) are located in the hollows 21. Each of the protrusions 22 formed on the outer surface of the ring magnet 20 constitutes part of an imaginary cylindrical shape which defines an outermost surface of the ring magnet 20. Thus, as viewed along a rotational axis (central axis) of the ring magnet 20, each of the protrusions 22 forms part of a circle (or an arc segment 23 in cross section) of which center lies on a central axis of a cylindrical inner surface of the ring magnet 20, or on the rotational axis of the ring magnet 20.

Generally, a sintered ring magnet has a problem that a distortion of the shape after sintering may occur as mentioned with reference to the foregoing second embodiment. If such a distortion of the ring shape occurs, the distance from the central axis of the ring magnet to the outermost surface thereof would vary from one protrusion to another formed on the generally cylindrical outer surface of the ring magnet. According to this embodiment, it is possible to equalize the distance from the central axis of the ring magnet 20 to the outermost surface thereof (or outer surfaces of the protrusions 22) by grinding or electric discharge machining of the outer surfaces of all the protrusions 22 so that the outer surfaces of the individual protrusions 22 fit in the aforementioned imaginary cylindrical shape centered on the rotational axis of the ring magnet 20.

When the sintered ring magnet 20 of the third embodiment is attached to a shaft and assembled into a motor together with a stator, the outermost surface of the ring magnet 20 (i.e., the outer surface of each protrusion 22) aligns with the aforementioned imaginary cylindrical shape of the ring magnet 20 centered on a rotational axis of the shaft. Therefore, it is possible to decrease and equalize gaps between the stator and the protrusions 22 of the ring magnet 20 according to the aforementioned structure of the present embodiment.

The gaps between the stator and the ring magnet 20 work as reluctance, or resistance to magnetic flux passing from the protrusions 22 of the ring magnet 20 to the stator. In the motor using the ring magnet 20 of this embodiment, the gaps between the stator and the individual protrusions 22 of the ring magnet 20 are equalized and, as a result, variations in the amount of magnetic flux passing from the ring magnet 20 into the stator from one magnetic pole to next are reduced. Variations in the amount of magnetic flux passing from the ring magnet 20 into the stator from one magnetic pole to next cause cogging torque. Thus, the ring magnet 20 of the third embodiment structured as discussed above serves to reduce the cogging torque.

As viewed along the central axis of the ring magnet 20, the arc segments 23 constituting the protrusions 22 should preferably take up approximately 20% to 80% of a full circle in terms of the ratio of the sum of central angles subtended by all of the arc segments 23 at the center of the circle (or at the central axis of the ring magnet 20) to an angular measure of the full circle area (360°).

The hollows 21 and the protrusions 22 are alternately formed around the generally cylindrical outer surface of the ring magnet 20 such that the hollows 21 exist on both sides of each magnetic pole as illustrated in FIG. 3, in which, as viewed in cross section along the central axis of the ring magnet 20, each hollow 21 is formed in an arc area which subtends a central angle equal to ⅕ of an angular extent of one magnetic pole subtended by the central angle thereof at the center of the circle (or at the central axis of the ring magnet 20), for example. More exactly, one half of the angular extent of each hollow 21 equals ⅕ of the angular extent of one magnetic pole in cross section as seen from the central axis of the ring magnet 20 in this example. The ring magnet 20 so structured can suppress fifth harmonic components related to magnetomotive force distribution. Likewise, if each hollow 21 is formed in an arc area which subtends a central angle equal to 1/7 of the angular extent of one magnetic pole subtended by the central angle thereof, the ring magnet 20 can suppress seventh harmonic components related to the magnetomotive force distribution.

The aforementioned fifth and seventh harmonic components are components of which repetition frequencies along a rotating direction (circumferential direction) of the ring magnet 20 are respectively 5 and 7 times a fundamental harmonic frequency of cyclically changing magnetomotive force produced by the ring magnet 20 along the rotating direction thereof, or the repetition frequency of N- and S-poles of the ring magnet 20. The fifth and seventh harmonic components due to the magnetomotive force distribution are main causes of cogging torque and torque ripple resulting from the cyclically changing magnetomotive force of the ring magnet 20.

To suppress the fifth harmonic components causing the cogging torque, at least part of the hollow 21 should exist in an arc area which subtends a central angle equal to ⅕ or more of an angular extent of each magnetic pole on each side (clockwise and counterclockwise) thereof as seen from the central axis of the ring magnet 20. Likewise, to suppress the seventh harmonic components causing the cogging torque, at least part of the hollow 21 should exist in an arc area which subtends a central angle equal to 1/7 or more of an angular extent of each magnetic pole on each side (clockwise and counterclockwise) thereof.

According to the present embodiment, it is possible to suppress the seventh harmonic components if the sum of the central angles subtended by all of the arc segments 23 excluding portions of the protrusions 22 is 5/7 or less than the full circle area (360°) of the ring magnet 20 as viewed in cross section. Also, it is possible to suppress both the fifth and seventh harmonic components if the sum of the central angles subtended by all of the arc segments 23 is ⅗ or less than the full circle area (360°) of the ring magnet 20 as viewed in cross section. Thus, the sum of the central angles subtended by all of the arc segments 23 should be 5/7 (71%) or less than the full circle area (360°) of the ring magnet 20.

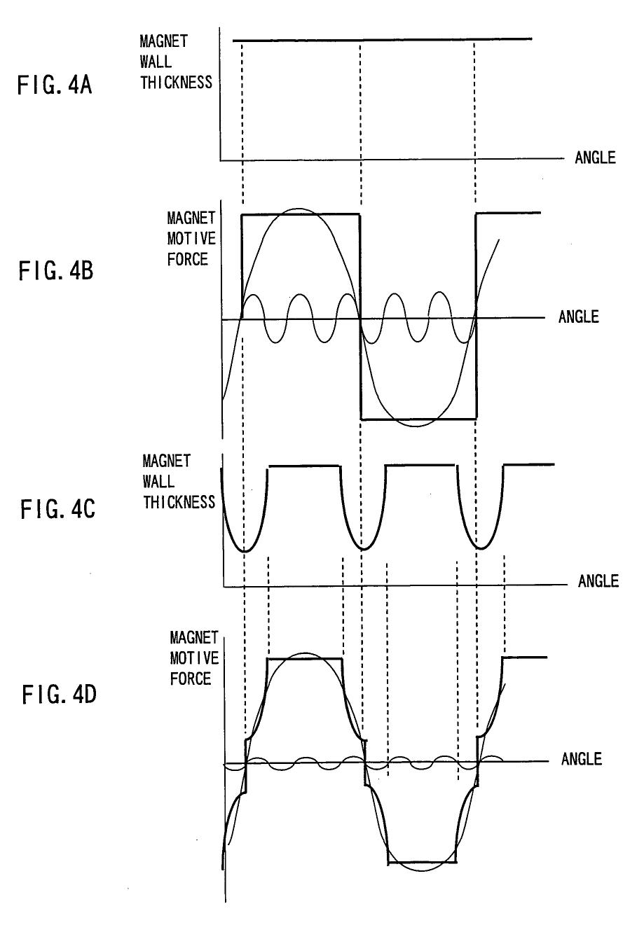

FIGS. 4A-4D are diagrams showing wall thicknesses and magnetomotive force distributions of an ordinary ring magnet with no hollows or protrusions formed on a cylindrical outer surface thereof and the ring magnet 20 of the embodiment with the parallel hollows 21 formed on the cylindrical outer surface thereof. Specifically, FIGS. 4A and 4B respectively show the wall thickness and the magnetomotive force distribution of the ordinary ring magnet without any corrugations on the cylindrical outer surface, whereas FIGS. 4C and 4D respectively show the wall thickness and the magnetomotive force distribution as well as fundamental and fifth harmonic components of the magnetomotive force of the ring magnet 20 having the hollows 21 and the protrusions 22 on the generally cylindrical outer surface. As can be seen from FIGS. 4C and 4D, the fifth harmonic components are suppressed due to the provision of the hollows 21.

Practically, a ring magnet has a wall thickness of approximately 3 mm and the amplitude of hollows and protrusions, or the magnitude of corrugations as measured from the top of the protrusions to the bottom of the hollows, is typically 1 to 2 mm. Distortion of the shape (wall thickness errors) of the ring magnet after sintering can be reduced to approximately 0.2 mm by reducing irregularities in the density of a ring-shaped powder compact when the ring-shaped powder compact is pressed in a magnetic field. In the aforementioned 8-pole ring magnet 20 of the embodiment, the wall thickness is 3 mm and the amplitude of the corrugations is 1.2 mm.

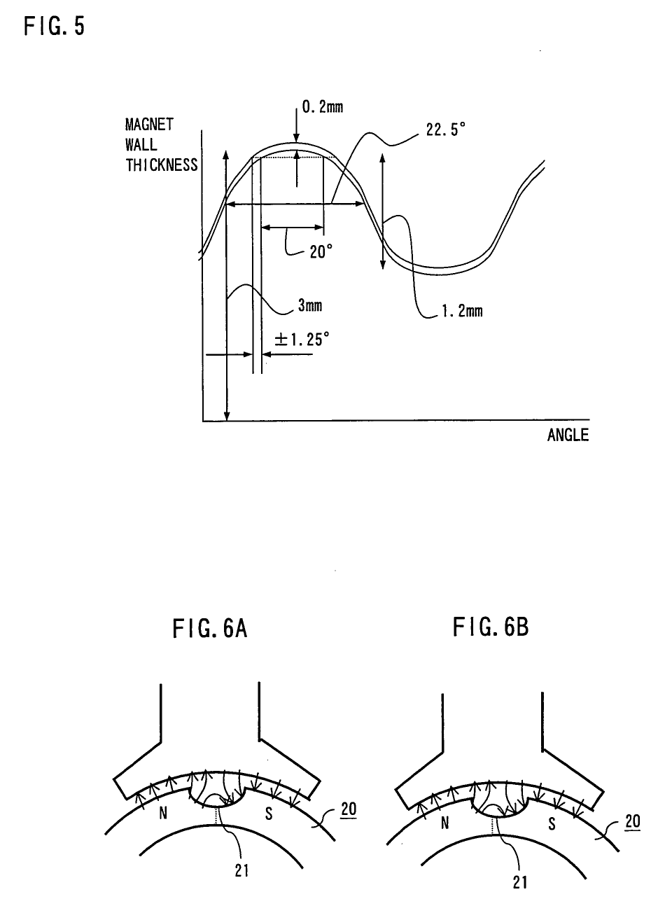

FIG. 5 is a diagram showing a relationship between the changing wall thickness and angular position along the rotating direction of the ring magnet 20. The ring-shaped powder compact has wall thickness errors of approximately 0.2 mm after sintering as mentioned above. If most protruding portions of the ring-shaped powder compact are scraped off over 20% of the width of each magnetic pole along the rotating direction of the ring magnet 20 such that the outer surfaces of the individual protrusions 22 (arc segments 23) fit in the aforementioned imaginary cylindrical shape centered on the central axis of the cylindrical inner surface of the ring magnet 20 as shown by a broken line in FIG. 5, for example, variations in the location of a boundary between each arc segment 23 and the adjacent hollow 21 along the rotating direction of the ring magnet 20 become approximately ±1.25° in terms of angular position. This level of position variations (±1.25°) is sufficiently small compared to ⅕ of the angular extent of each magnetic pole, or 90 corresponding to one half of the angular extent of each hollow 21 needed for suppressing the fifth harmonic components, for instance.

It is understood from the foregoing discussion that, as viewed along the central axis of the ring magnet 20, the arc segments 23 constituting the protrusions 22 should preferably take up approximately 20% to 80% of a full circle in terms of the ratio of the sum of the central angles subtended by all of the arc segments 23 at the central axis of the ring magnet 20 to the angular measure of the full circle area (360°) as previously mentioned.

As discussed earlier, the magnetic poles formed on the sintered ring magnet 20 run parallel to the hollows 21 and the protrusions 22 at the same skew angle with respect to the axial direction of the ring magnet 20 (FIG. 3). While the boundaries between the adjacent magnetic poles are in the individual hollows 21 as shown in FIG. 3, the boundaries need not necessarily be located exactly at the middle of the width of each hollow 21. As shown in FIGS. 6A and 6B, magnetic flux formed in the vicinity of the boundary between any two adjacent magnetic poles (N- and S-poles) does not reach the stator but extends from the N-pole and reaches the adjacent S-pole passing through an air gap (at one of the hollows 21) between the ring magnet 20 and the stator. Therefore, main magnetic fluxes which reach the stator and produce torque are determined by the shape of the arc segments 23 constituting the protrusions 22 along the imaginary cylindrical shape which defines the outermost surface of the ring magnet 20. This structure of the third embodiment makes it possible to produce a sufficient cogging torque reduction effect even if magnetizing accuracy or positioning accuracy of the ring-shaped powder compact and a magnetizing yoke is low.

The protrusions 22 forming the generally cylindrical outer surface of the ring magnet 20 may be formed by grinding, wire-cut electron discharge method or electric discharge machining, for instance. Alternatively, if a desired level of magnet shape accuracy after sintering is achievable by improving sintering accuracy, the ring-shaped powder compact may be formed into the shape of the finished ring magnet 20 with no machining without sacrificing the aforementioned advantages of the present embodiment.

If the outer surfaces of the protrusions 22 (arc segments 23) defining the generally cylindrical shape of the ring magnet 20 are shaped to a dimensional accuracy equal to or less than ⅕ of the distance between the stator and the protrusions 22 of the ring magnet 20, fluctuations in the amount of magnetic fluxes passing from the ring magnet 20 into the stator are 5% or less. Influence of this level of fluctuations in the amount of magnetic fluxes to the cogging torque is practically negligible. If the ring magnet 20 has a wall thickness of 3 mm and average distance between the stator and the ring magnet 20 is 0.5 mm, fluctuations in the amount of magnetic fluxes passing from the ring magnet 20 into the stator are 3% or less. Generally, motors employing a sintered neodymium-ion-boron ring magnet have an output power rating of a few hundred watts, so that the ratio of the wall thickness of the ring magnet to the distance between the stator and the ring magnet does not change so much from that of the structure shown in the foregoing discussion.

### Fourth Embodiment

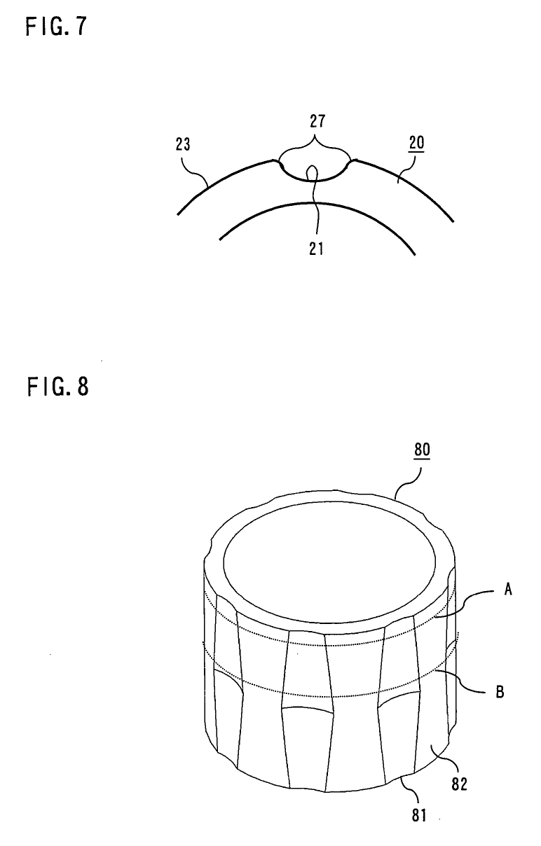

FIG. 7 is a fragmentary plan view of a sintered ring magnet 20 according to a fourth embodiment of the invention. The sintered ring magnet 20 of this embodiment is a sintered magnet containing neodymium, iron and boron as main components like the sintered ring magnet 10 of the first embodiment. A generally cylindrical outer surface of the sintered ring magnet 20 is corrugated with alternating hollows 21 and protrusions 22 formed along the sintered ring magnet 20. The hollows 21 and the protrusions 22 are formed in parallel lines skewed by a specific inclination angle (skew angle) with respect to an axial direction of the sintered ring magnet 20. Magnetic poles of the sintered ring magnet 20 are formed such that the magnetic poles are aligned parallel to the hollows 21 and the protrusions 22 at the same skew angle with respect to the axial direction of the sintered ring magnet 20. Boundaries of these magnetic poles are located in the hollows 21. Each of the protrusions 22 formed on the outer surface of the ring magnet 20 constitutes part of an imaginary cylindrical shape which defines an outermost surface of the ring magnet 20. Thus, as viewed along a rotational axis (central axis) of the ring magnet 20, each of the protrusions 22 forms part of a circle (or an arc segment 23 in cross section) of which center lies on the central axis of the ring magnet 20. In this embodiment, there are formed rounded corners 27 along boundaries between the arc segment 23 forming each protrusion 22 and the adjacent hollows 21 on the generally cylindrical outer surface of the sintered ring magnet 20 as shown in the plan view of FIG. 7.

Since the rounded corners 27 are formed along the boundaries between the individual protrusions 22 and the adjacent hollows 21, there are not created any sharp edges on the outer surface of the ring magnet 20 as can be seen from FIG. 7. More specifically, the ring magnet 20 of the present embodiment is an 8-pole ring magnet having a generally cylindrical corrugated outer surface with a maximum outside diameter of 30 mm, a maximum wall thickness of 3 mm (at the protrusions 22) and a minimum wall thickness of 1.8 mm (at the hollows 21), for example, in which the rounded corners 27 having a radius of curvature of 1.5 mm are formed along the boundaries between the arc segments 23 which constitute the protrusions 22 and the adjacent hollows 21. If no such rounded corners are formed along the boundaries between each arc segment 23 and the adjacent hollows 21, surface magnetic flux density measured in a rotating direction of the ring magnet 20 locally increases by about 10% at the location of each rounded corner 27. This kind of local increase in surface magnetic flux density of the ring magnet 20 can be suppressed with the provision of the rounded corners 27 along the boundaries between the arc segments 23 and the hollows 21. Advantageous effect of the rounded corners 27 discussed above is obtained if the radius of curvature of the rounded corners 27 measured in cross section is 0.5 mm or more.

Generally, the density of magnetic flux formed by a ring magnet increases at sharp-edged portions thereof. If such a sharp-edged portion does not uniformly exist along the axial direction of the ring magnet, the ring magnet will have regions where strong magnetic forces occur, resulting in an increase in cogging torque. The sharp-edged portions of the ring magnet are a cause of cogging torque of which number of oscillations per rotation of a motor corresponds to the number of slots formed in a stator, for example. The rounded corners 27 formed on the sintered ring magnet 20 of the present embodiment serve to eliminate this causal factor of the cogging torque.

In particular, if dummy slots are formed in the stator to produce a dummy slot effect and the number of oscillations of the cogging torque in the rotating direction is increased to reduce the cogging torque, the aforementioned advantageous effect of the fourth embodiment will be enhanced.

### Fifth Embodiment

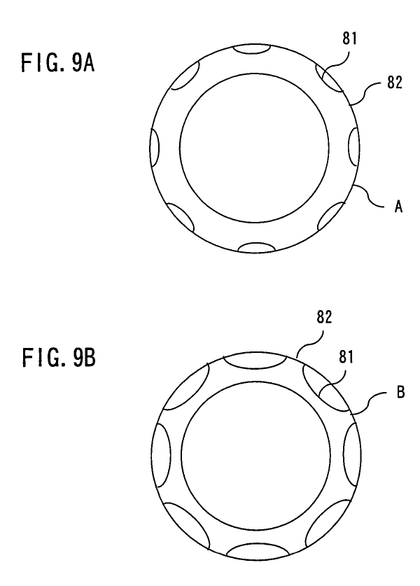

FIG. 8 is a perspective view of a sintered ring magnet 80 according to a fifth embodiment of the invention. The sintered ring magnet 80 of this embodiment is an 8-pole ring magnet having corrugations (alternating hollows 81 and protrusions) formed at regular intervals around a generally cylindrical outer surface thereof. As viewed along a rotational axis (central axis) of the ring magnet 80, outermost surfaces of the sintered ring magnet 80 each form part of a circle (or an arc segment 82 in cross section) of which center lies on a central axis of a cylindrical inner surface of the ring magnet 80, or on the central axis of the ring magnet 80. All of the protrusions on the generally cylindrical outer surface of the sintered ring magnet 80 are formed by such arc segments 82 as viewed in cross section. FIGS. 9A and 9B are diagrams showing examples of cross-sectional shapes of the sintered ring magnet 80 taken by planes perpendicular to the central axis thereof along broken lines (circles) A and B of FIG. 8, respectively. As can be seen from FIGS. 8, 9A and 9B, the cross-sectional shape of the sintered ring magnet 80 varies with the position of the cross section along the central axis of the ring magnet 80. Specifically, the hollows 81 formed on the outer surface of the sintered ring magnet 80 become narrower and shallower toward both ends of the sintered ring magnet 80 along the central axis thereof, wider and deeper toward a mid-length position along the central axis as shown in FIGS. 9A and 9B. Boundaries of magnetic poles (eight poles in total in the example of FIG. 8) are located in the hollows 81.

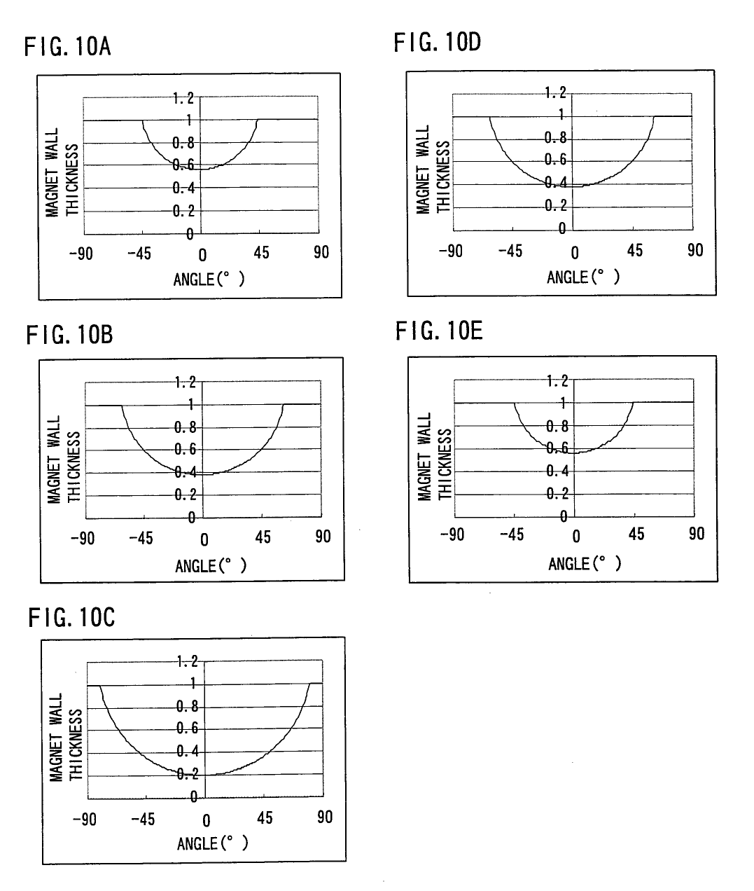

FIGS. 10A-10E are diagrams showing in detail how the wall thickness of the ring magnet 80 varies along a rotating direction (circumferential direction) from one position to next along an axial direction of the ring magnet 80. The wall thickness of the ring magnet 80 varies in a pattern corresponding to a distribution pattern of magnetomotive force produced by the ring magnet 80, so that the quantity indicated by vertical axes of FIGS. 10A-10E, or the magnet wall thickness, may be regarded as representing the absolute value of magnetomotive force produced by the ring magnet 80. When polarities of the individual magnetic poles are taken into consideration, the magnetomotive force produced by the ring magnet 80 takes positive and negative values in alternate turns at N- and S-poles. It is to be noted that although the sintered ring magnet 80 of this embodiment is actually an 8-pole ring magnet, the magnet wall thickness is shown as if the ring magnet 80 has two magnetic poles only over a full circle range (360°) corresponding to one cycle of magnetic polarities in FIGS. 10A-10E for simplicity of illustration and explanation. Specifically, FIGS. 10A-10E cover an angular range of 180° (−90° to +90°) on horizontal axes from a midpoint of one magnetic pole to a midpoint of the other magnetic pole. In actuality, the magnetomotive force distribution pattern shown in FIGS. 10A-10E is repeated four times over the full circle range in the 8-pole ring magnet 80 illustrated in FIGS. 8, 9A and 9B.

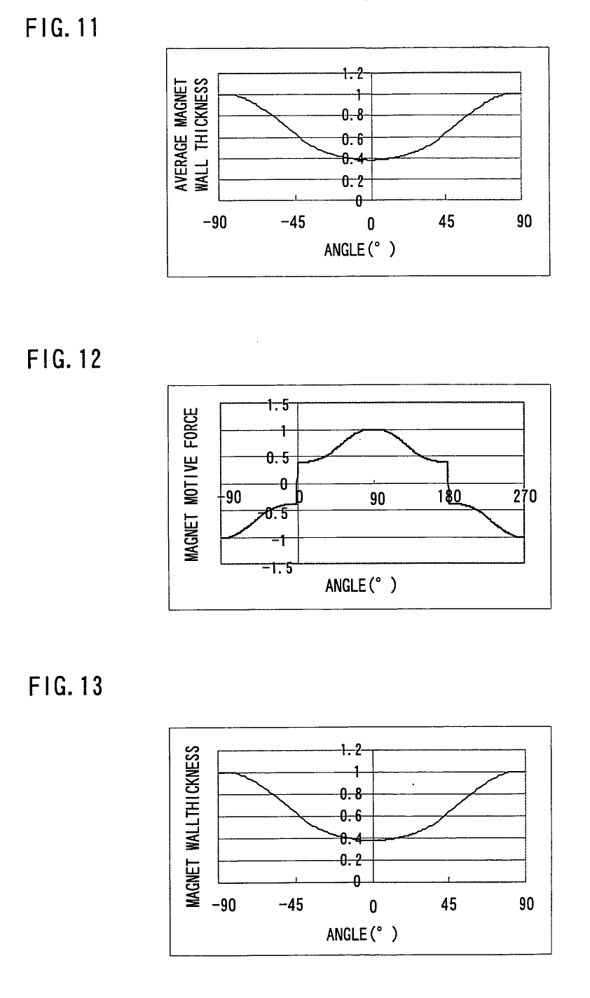

FIG. 11 is a diagram showing how average magnet wall thickness corresponding to average magnetomotive force of the ring magnet 80 of FIGS. 10A-10E varies along the axial direction thereof. A total magnetomotive force actually contributing to producing a torque when the ring magnet 80 is used in a motor is a cumulative sum of magnetomotive forces along the axial direction of the ring magnet 80, so that the total magnetomotive force produced by the ring magnet 80 can be estimated from the average magnetomotive force along the axial direction of the ring magnet 80.

FIG. 12 is a diagram showing a magnetomotive force distribution pattern of the ring magnet 80 of FIGS. 10A-10E with the polarities of the magnetic poles taken into consideration, in which it is assumed that the ring magnet 80 is magnetized such that each boundary between the adjacent N- and S-poles is at an angular position within one of the hollows 81 where the magnet wall thickness is minimal (see FIGS. 10A-10E).

Torque fluctuations occurring when a motor incorporating a ring magnet is running are caused by changes in the amount of rotating magnetic flux passing from the ring magnet into a stator. Generally, it is necessary to estimate how cumulative sums of magnetomotive forces along the axial direction of the ring magnet are distributed in the rotating direction thereof and configure the ring magnet in such a manner that average magnetomotive forces of the ring magnet are distributed in a pattern resembling a sine-wave distribution pattern rather than a rectangular distribution pattern in the rotating direction of the ring magnet.

In the ring magnet 80 of the present embodiment, each of the hollows 81, as seen in cross section, forms part of an ellipse of which major axis and minor axis become shorter from the mid-length position of the ring magnet 80 toward both ends thereof in proportion to the distance from the mid-length position. The hollows 81 are shaped such that the ratio of the sum of the widths of the hollows 81 along the rotating direction (circumferential direction) of the ring magnet 80 to the circumference thereof varies from 80% to 20% and the depth of the hollows 81 varies from 80% to 20% with the distance from the mid-length position. The ring magnet 80 of this embodiment can suppress fifth and seventh harmonic components of a sine-wave fundamental component caused by the magnetomotive force distribution to 45% and 60% or less, respectively, compared to harmonic components of a rectangular magnetomotive force distribution pattern produced by a ring magnet having no surface corrugations. Hence, it is possible to suppress harmonic components due to distortion of the magnetomotive force distribution pattern, which is a causal factor of cogging torque, and thereby reduce the cogging torque.

Even when a ring magnet has a wall thickness distribution as illustrated in FIG. 13 and wall thicknesses are uniform along the axial direction of the ring magnet, the ring magnet produces generally the same magnetomotive force distribution as described above, creating an advantage equivalent to what has been discussed above. In the case of a sintered magnet, however, shape distortion occurring in a sintering process is so large that it is difficult to create a wall thickness distribution pattern resembling a sine wave with high precision. Since the precision of the shape of a sintered ring magnet is low, considerable irregularities in magnetomotive force distribution occur in the ring magnet, resulting in an increase in cogging torque.

In the case of the sintered ring magnet 80 of the present embodiment shaped as described above, the hollows 81 formed in areas of the generally cylindrical outer surface of the ring magnet 80 which are not part of the circle as seen in cross section (or the arc segment 82) constitute relatively deep parallel grooves. Even if the hollows 81 are formed with low precision and there are variations in the depth of the hollows 81, the ring magnet 80 can be configured such that the cumulative sums of the magnetomotive forces along the axial direction are distributed in a pattern resembling a sine-wave distribution pattern in the rotating direction with high precision. Therefore, it is possible to achieve a great cogging torque reduction effect.

The sintered neodymium-ion-boron ring magnet of the present invention is manufactured by pressing magnetic powder and then sintering a ring-shaped powder compact. Since the ring-shaped powder compact shrinks when sintered, it is relatively difficult to achieve a high level of magnet shape accuracy. The ring-shaped powder compact may be formed into the shape of the finished ring magnet having the generally cylindrical outer surface by grinding operation. Alternatively, if a desired level of magnet shape accuracy after sintering is achievable by improving sintering accuracy, the ring-shaped powder compact may be formed into the shape of the finished ring magnet without any machining operation.

The sintered ring magnet 80 shown in FIG. 8 is an example of a ring magnet in which the hollows 81 are symmetrically formed from the mid-length position of the ring magnet 80 toward both ends thereof. The ring magnet 80 thus configured is well balanced about a center of gravity and, therefore, the ring magnet 80 of the embodiment has an advantage that the same can reduce acoustic noise and vibrations when used in a motor.

While the sintered ring magnet 80 of the fifth embodiment is symmetrical about the mid-length position thereof, the embodiment may be modified such that each of the hollows 81 is wide at one end of the ring magnet 80 along the longitudinal axis thereof and narrow at the opposite end, for example, yet producing the same cogging torque reduction effect as discussed above.

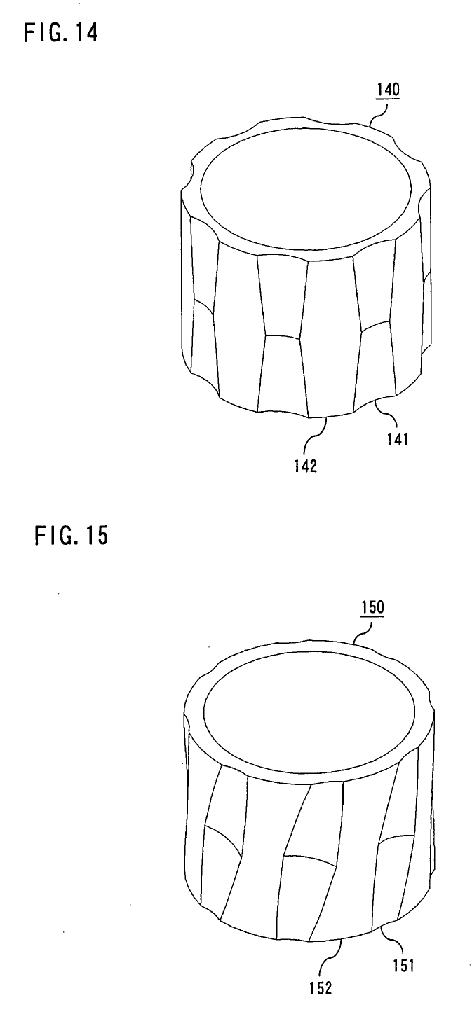

FIG. 14 is a perspective view of a sintered ring magnet 140 in another modified form of the fifth embodiment of the invention. What is characteristic of the sintered ring magnet 140 of FIG. 14 is that hollows 141 formed on the outer surface of the sintered ring magnet 140 become wider and deeper toward both ends of the sintered ring magnet 140 along the central axis thereof, narrower and shallower toward the mid-length position along the central axis. In the ring magnet 140 of this modified form of the embodiment, each of the hollows 141, as seen in cross section, forms part of an ellipse of which major axis and minor axis become longer from the mid-length position of the ring magnet 140 toward both ends thereof in proportion to the distance from the mid-length position. The sintered ring magnet 140 of FIG. 14 thus shaped can also produce the same advantageous effect as discussed above.

### Sixth Embodiment

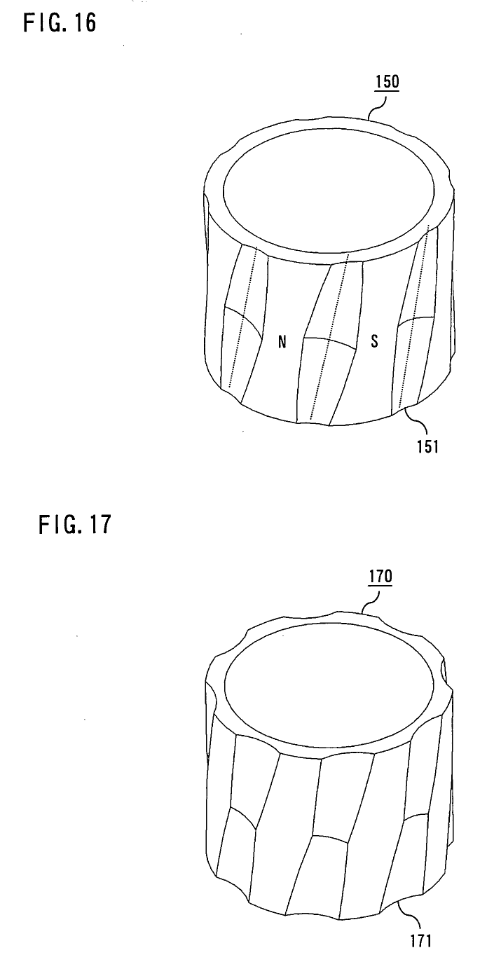

FIG. 15 is a perspective view of a sintered ring magnet 150 according to a sixth embodiment of the invention. The sintered ring magnet 150 of this embodiment is an 8-pole ring magnet having corrugations (alternating hollows 151 and protrusions) formed at regular intervals around a generally cylindrical outer surface thereof. As viewed along a rotational axis (central axis) of the ring magnet 150, outermost surfaces of the sintered ring magnet 150 each form part of a circle (or an arc segment 152 in cross section) of which center lies on the central axis of the ring magnet 150. All of the protrusions on the generally cylindrical outer surface of the sintered ring magnet 150 are formed by such arc segments 152 as viewed in cross section. As is the case with the ring magnet 10 of the first embodiment, the cross-sectional shape of the ring magnet 150 taken by a plane perpendicular to the central axis thereof varies with the position of the cross section along the central axis of the ring magnet 150. While the corrugations formed on the ring magnet 150 are shaped like the ring magnet 80 of the fifth embodiment in cross section as viewed along the central axis, the corrugations of the ring magnet 150 are skewed as illustrated in FIG. 15. Specifically, the corrugations formed on the ring magnet 150 are shaped as if the corrugations on the ring magnet 80 shaped as depicted in FIGS. 9A, 9B, 10A-10E are skewed about the central axis along the length of the ring magnet 80. Magnetic poles (eight poles in total in the example of FIG. 15) of the sintered ring magnet 150 are formed by skewed magnetization and boundaries of the magnetic poles are located in the hollows 151 as shown by broken lines in FIG. 16.

The sintered ring magnet 150 of the sixth embodiment can reduce distortion of a magnetomotive force distribution. When incorporated in a motor, the sintered ring magnet 150 serves to reduce torque fluctuations, such as cogging torque and torque ripple, by virtue of skewed magnetization design. In this embodiment, a cogging torque reduction effect is obtained at a skew angle of 15° or 18°. Compared to an ordinary ring magnet, the sintered ring magnet 150 of the embodiment can reduce cogging torque to ⅓ or less.

FIG. 17 is a perspective view of a sintered ring magnet 170 in a modified form of the sixth embodiment of the invention. The sintered ring magnet 170 of FIG. 17 is an 8-pole ring magnet having corrugations (alternating hollows 171 and protrusions) formed at regular intervals around a generally cylindrical outer surface thereof. As viewed along a rotational axis (central axis) of the ring magnet 170, outermost surfaces of the sintered ring magnet 170 each form part of a circle (or an arc segment in cross section) of which center lies on the central axis of the ring magnet 170. All of the protrusions on the generally cylindrical outer surface of the sintered ring magnet 170 are formed by such arc segments as viewed in cross section. While the cross-sectional shape of the ring magnet 170 taken by a plane perpendicular to the central axis thereof is similar to that of the ring magnet 140 of FIG. 14, the corrugations formed on the ring magnet 170 are skewed with respect to an axial direction thereof. Magnetic poles (eight poles in total in the example of FIG. 17) of the sintered ring magnet 170 are formed by skewed magnetization and boundaries of the magnetic poles extend parallel to the hollows 171. The sintered ring magnet 170 of FIG. 17 thus shaped can also produce the same advantageous effect as discussed above.

### Seventh Embodiment

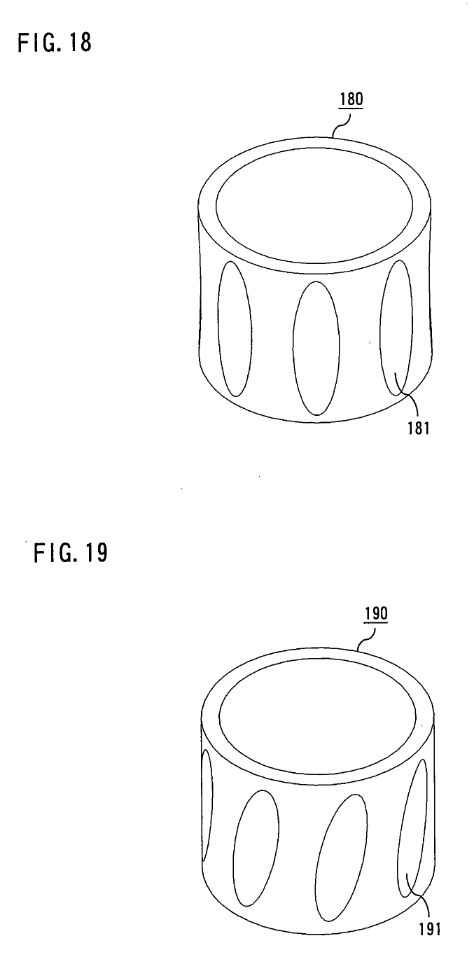

FIG. 18 is a perspective view of a sintered ring magnet 180 according to a seventh embodiment of the invention. There are formed oval-shaped hollows 181 in specific areas of a generally cylindrical outer surface of the sintered ring magnet 180 along an axial direction thereof, both axial ends of the ring magnet 180 having a circle-shaped outer periphery as viewed along the axial direction. The ring magnet 180 of this embodiment is otherwise shaped essentially in same fashion as the ring magnets of the foregoing embodiments.

The sintered ring magnet 180 of the seventh embodiment generates a larger amount of magnetic flux so that, when incorporated in a motor, the ring magnet 180 helps produce a greater output power while suppressing cogging torque. Additionally, the ring magnet 180 of the embodiment serves to reduce the amount of exciting current and thereby improve motor efficiency. Moreover, the ring magnet 180 of the embodiment features greater mechanical strength.

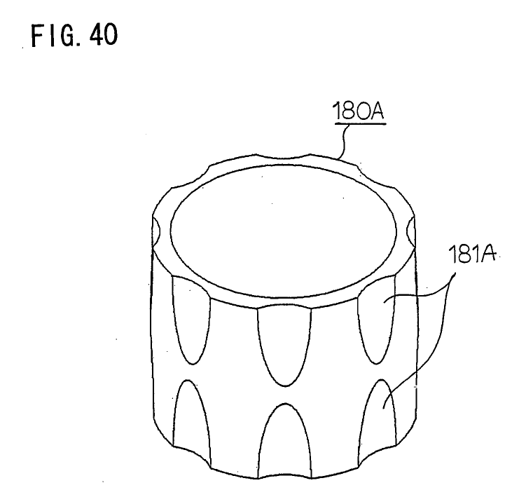

The aforementioned advantages of the embodiment are obtained when the areas where the oval-shaped hollows 181 are formed are 5% to 30% of the longitudinal length of the ring magnet 180. While FIG. 18 shows an example in which the oval-shaped hollows 181 are formed such that both axial ends of the ring magnet 180 has a circle-shaped outer periphery, the embodiment may be modified as illustrated in FIG. 40. Specifically, in this modified form of the seventh embodiment shown in FIG. 40, a sintered ring magnet 180A has semielliptical hollows 181A formed in a generally cylindrical outer surface thereof in such a fashion that short axes (or long axes) of the semielliptical hollows 181A lie at both axial ends of the ring magnet 180A and a cross section of the ring magnet 180A taken by a plane perpendicular to a central axis thereof at a mid-length position along the central axis is circle-shaped.

FIG. 19 is a perspective view of a sintered ring magnet 190 in another modified form of the seventh embodiment of the invention. What is characteristic of the sintered ring magnet 190 of FIG. 19 is that oval-shaped hollows 191 are formed in specific areas of a generally cylindrical outer surface of the ring magnet 190 and these hollows 191 are skewed with respect to an axial direction of the ring magnet 190. Therefore, the ring magnet 190 of this modified form has an advantage that the cogging torque can be further suppressed by virtue of skewed magnetization design in addition to the aforementioned advantages of the seventh embodiment. The same advantage will be obtained if the semielliptical hollows 181A of the sintered ring magnet 180A shown in FIG. 40 are skewed about the central axis thereof.

### Eighth Embodiment

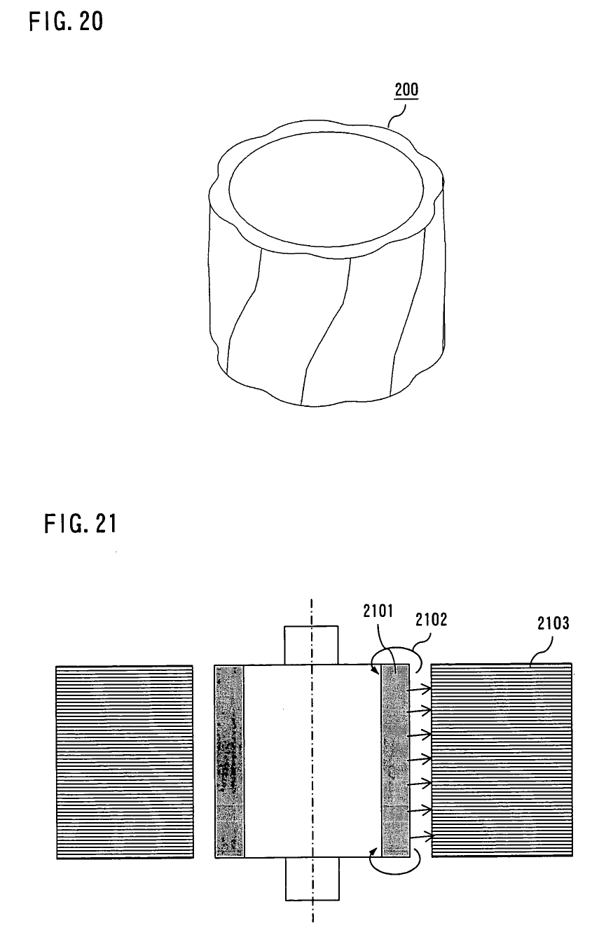

FIG. 20 is a perspective view of a sintered ring magnet 200 according to an eighth embodiment of the invention.

Generally, magnetic flux 2102 generated by a ring magnet 2101 does not reach a stator 2103 in its entirety but part of the magnetic flux 2102 departing from longitudinal end portions of the ring magnet 2101 passes through a gap between the ring magnet 2101 and the stator 2103 and returns to the ring magnet 2101. Consequently, the amount of effectively working magnetic flux decreases at the longitudinal end portions of the ring magnet 2101. Although skewed magnetization whereby magnetic poles are formed at an oblique angle to an axial direction of the ring magnet 2101 produces a cogging torque reduction effect when the magnetic flux 2102 is uniformly generated, the cogging torque reduction effect lessens when the generated magnetic flux 2102 is not uniformly distributed.

To compensate for a reduction in the amount of magnetic flux at longitudinal end portions of the sintered ring magnet 200, the ring magnet 200 of the eighth embodiment shown in FIG. 20 is magnetized such that skew angle of magnetic poles formed on a generally cylindrical outer surface of the ring magnet 200 becomes smaller toward both axial ends thereof (or such that boundaries of the magnetic poles become nearly parallel to a longitudinal axis of the ring magnet 200 as seen from outside the generally cylindrical outer surface thereof). This structure of the ring magnet 200 makes it possible to compensate for fluctuations of the amount of the magnetic flux and obtain a higher cogging torque reduction effect.

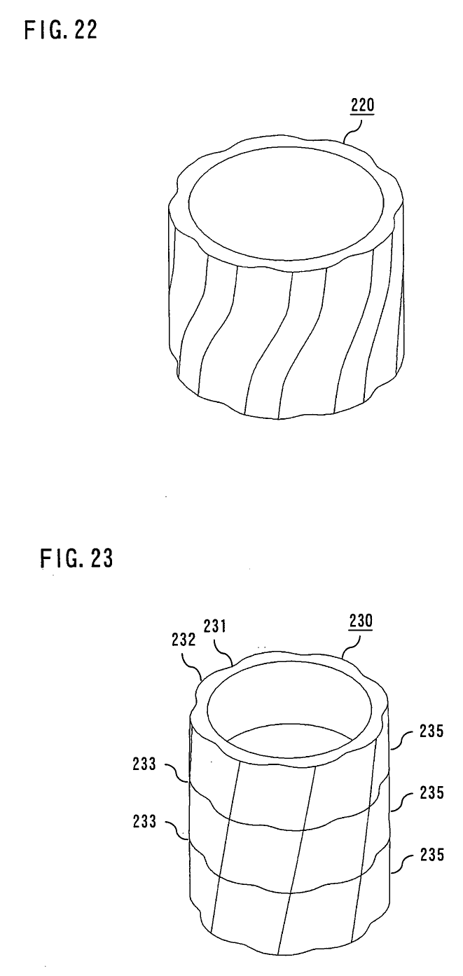

FIG. 22 is a perspective view of a sintered ring magnet 220 in one modified form of the eighth embodiment of the invention. The sintered ring magnet 220 shown in FIG. 22 is an example in which, as viewed along a central axis of the ring magnet 220, outermost surfaces of the ring magnet 220 each form part of a circle (or an arc segment in cross section) of which center lies on the central axis of the ring magnet 220. When incorporated in a motor, the ring magnet 220 thus structured compensates for fluctuations of the amount of magnetic flux and produces the cogging torque reduction effect by virtue of skewed magnetization design. Additionally, the motor incorporating the ring magnet 220 of this modified form can produce an increased output power with reduced cogging torque.

Depending on magnet manufacturing method, magnetic properties of a sintered ring magnet could vary along the axial direction due to variations in magnetic orientation characteristics or impurities contained in the magnet, for instance. Therefore, the sintered ring magnet may be structured such that the skew angle decreases in areas where the amount of generated magnetic flux is small.

### Ninth Embodiment

FIG. 23 is a perspective view of a sintered ring magnet 230 of which generally cylindrical outer surface is corrugated with alternating hollows 231 and protrusions 232 formed along the sintered ring magnet 230 according to a ninth embodiment of the invention. The sintered ring magnet 230 shown in FIG. 23 is produced by stacking a plurality of ring-shaped powder compacts 235 and sintering a stacked ring-shaped powder compact assembly. The sintered ring magnet 230 thus structured has interlayer boundaries 233 which are perpendicular to an axial direction of the ring magnet 230. These interlayer boundaries 233 occur during a manufacturing process of the ring magnet 230. The ring-shaped powder compact 235 of the ninth embodiment has the same external shape as the sintered ring magnet 10 of the first embodiment (FIG. 1), which is a typical example of the sintered ring magnet of the present invention.

The aforementioned structure of the present embodiment makes it possible to produce a sintered ring magnet having a large axial length featuring a capability to generate an increased amount of effectively working magnetic flux. The sintered ring magnet 230 of this embodiment can be used for manufacturing a motor having an increased output power rating without increasing the external size of the motor with reduced cogging torque. The interlayer boundaries 233 can be identified as regions where magnetic flux density decreases by measuring the magnetic flux density on the surface of the ring magnet 230 by use of a Hall-effect device, for example.

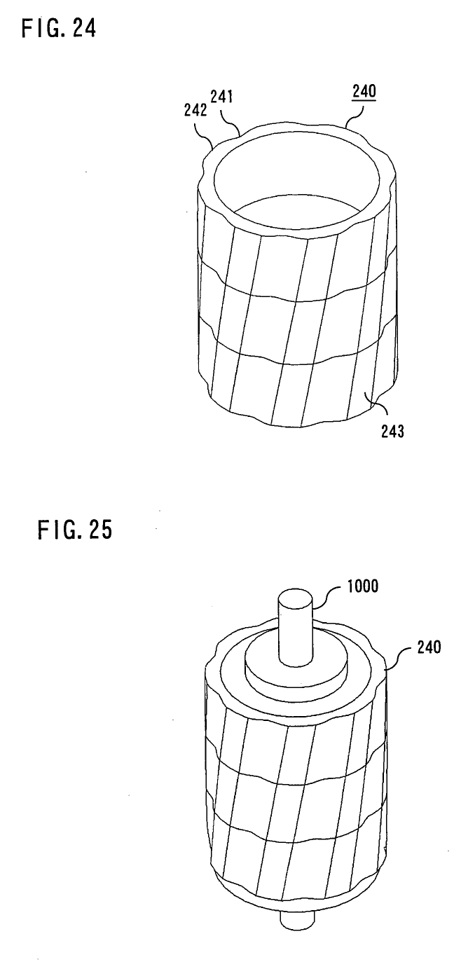

FIG. 24 is a perspective view of a sintered ring magnet 240 of which generally cylindrical outer surface is corrugated with alternating hollows 241 and protrusions 242 in one modified form of the ninth embodiment of the invention. As viewed along a central axis of the ring magnet 240, outermost surfaces of the sintered ring magnet 240 each form part of a circle (or an arc segment 243 in cross section) of which center lies on the central axis of the ring magnet 240. When used in a motor, the ring magnet 240 of this modified form of the embodiment can decrease and equalize gaps between a stator and the individual protrusions 242 and increase the amount of effectively working magnetic flux with reduced variations among individual magnetic poles. The ring magnet 240 serves to increase torque generated by the motor, improve motor efficiency and reduce cogging torque.

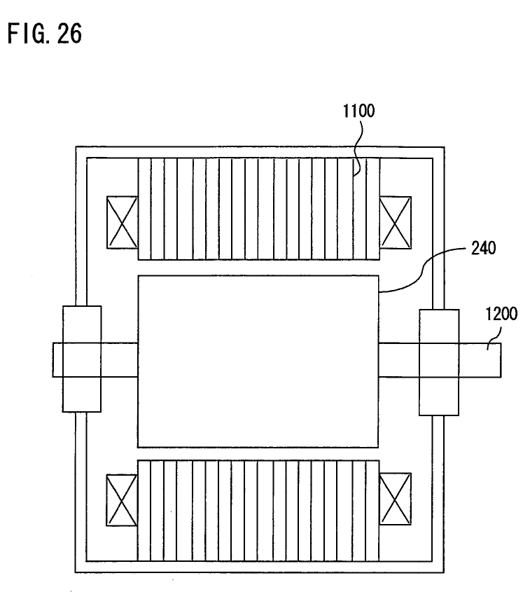

FIG. 25 is a perspective view showing the sintered ring magnet 240 as it is firmly fitted on a shaft 1200 and FIG. 26 is a cross-sectional view of a motor formed by assembling the sintered ring magnet 240 fitted on the shaft 1200 with a stator 1100.

While the sintered ring magnet 230 (240) having interlayer boundaries is structured by stacking ring-shaped powder compacts having the same outer contour in cross section in the ninth embodiment discussed above, a sintered ring magnet having interlayer boundaries may be produced by stacking ring-shaped powder compacts having different outer contours.

In the above-described ninth embodiment and the modified form thereof, the ring-shaped powder compacts are stacked in such a fashion that the outer contour of an end surface of one ring-shaped powder compact matches the outer contour of a facing end surface of another ring-shaped powder compact as can be seen from FIGS. 23 and 24. If the individual ring-shaped powder compacts are stacked in this fashion, sharp-edged projecting parts are not formed on the generally cylindrical outer surface of the sintered ring magnet 230 (240). Magnetic flux density sharply increases at sharp-edged projecting parts, if formed on the outer surface of a sintered ring magnet, causing cogging torque. If the ring-shaped powder compacts are stacked such that the outer contours of their facing end surfaces match up with one another, it is possible to prevent a sharp increase in magnetic flux density and thereby reduce the cogging torque.

### Tenth Embodiment

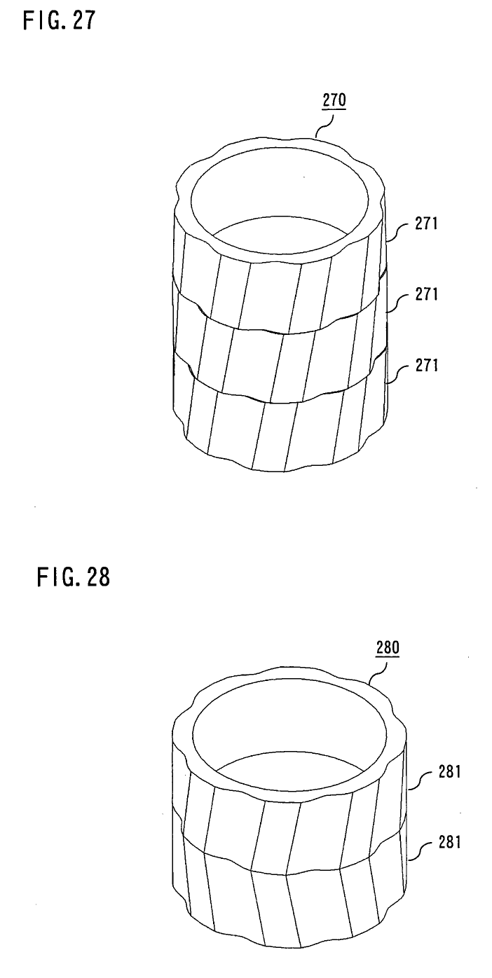

FIG. 27 is a perspective view of a sintered ring magnet 270 according to a tenth embodiment of the invention. While the sintered ring magnet 270 of this embodiment is produced by stacking a plurality of ring-shaped powder compacts 271 like the sintered ring magnet 230 of the ninth embodiment, the individual ring-shaped powder compacts 271 of the ring magnet 270 are stacked with a specific layer-to-layer angular displacement so that outer contours of facing end surfaces of the adjacent ring-shaped powder compacts 271 do not match up with each another. According to this embodiment, it is possible to reduce cogging torque by stacking the individual ring-shaped powder compacts 271 with a layer-to-layer angular displacement which is determined such that cogging torque generated by the ring-shaped powder compact 271 in one layer cancels out cogging torque generated by the ring-shaped powder compact 271 in another layer, or such that phases of the cogging torques generated by the individual ring-shaped powder compacts 271 are displaced from one another.

If a sintered ring magnet according to this embodiment having eight magnetic poles is used in a motor of which stator has 12 slots, the motor produces cogging torque causing 24 vibrations per rotation, that is, at intervals of 15° (=360°÷24). If the ring-shaped powder compacts 271 are stacked with a layer-to-layer angular displacement of half this 15° interval, or 7.5°, vibrations due to the cogging torque generated by the adjacent ring-shaped powder compacts 271 are canceled out each other, resulting in an overall cogging torque reduction.

### Eleventh Embodiment

FIG. 28 is a perspective view of a sintered ring magnet 280 according to an eleventh embodiment of the invention. The ring magnet 280 of this embodiment is another example of a sintered ring magnet having an interlayer boundary which is perpendicular to an axial direction of the ring magnet. Specifically, the sintered ring magnet 280 shown in FIG. 28 is formed by stacking and sintering two (upper and lower) ring-shaped powder compacts 281, each having a generally cylindrical outer surface which is corrugated with alternating hollows and protrusions formed at regular intervals in a circumferential direction. In this embodiment, the hollows and the protrusions formed on the upper and lower ring-shaped powder compacts 281 are skewed in opposite directions on opposite sides of an interlayer boundary as illustrated. This structure of the ring magnet 280 can cancel out, or average, forces exerted on the individual ring-shaped powder compacts along the axial direction and thereby reduce acoustic noise and vibrations when used in a motor.

### First Manufacturing Method

A ring magnet pressing unit (metal die unit) and a pressing process used in a first method of manufacturing sintered ring magnets according to the foregoing embodiments are described.

Raw material used for manufacturing a sintered ring magnet of the invention is a magnetic alloy like Nd₂Fe₁₄B, for example. The prepared magnetic alloy is coarsely crushed and subjected to a hydrogen embrittlement treatment. Then, the magnetic alloy thus treated is pulverized into fine magnetic powder having an average particle size of about 4 micrometers by using a jet mill. A ring-shaped powder compact is formed by pressing the fine magnetic powder while magnetizing the same in a radial orientation pattern by a procedure discussed below.

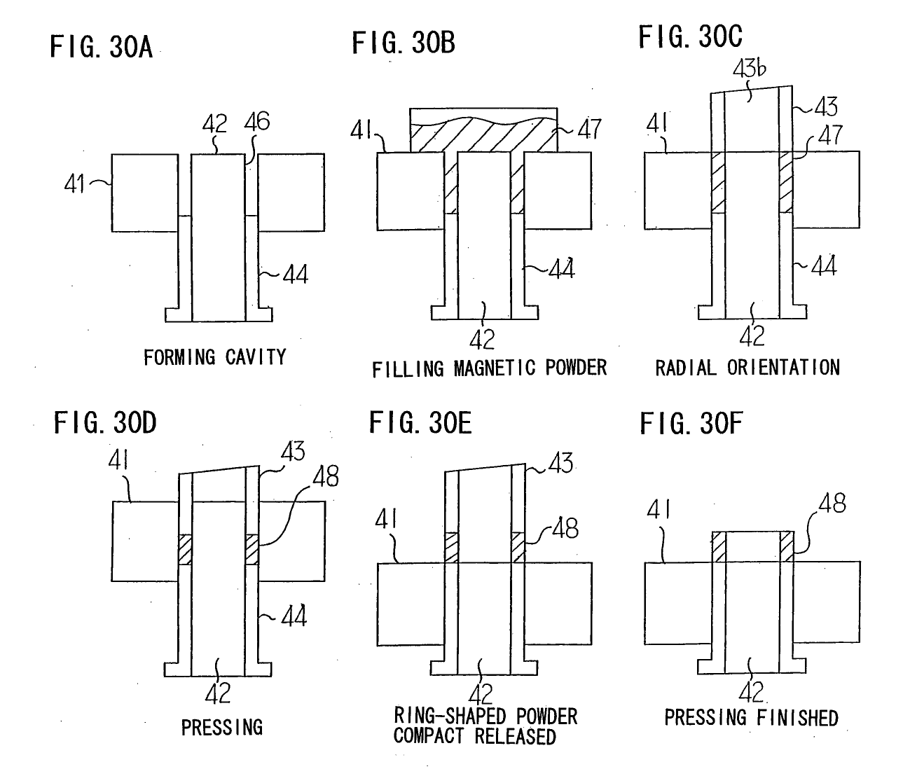

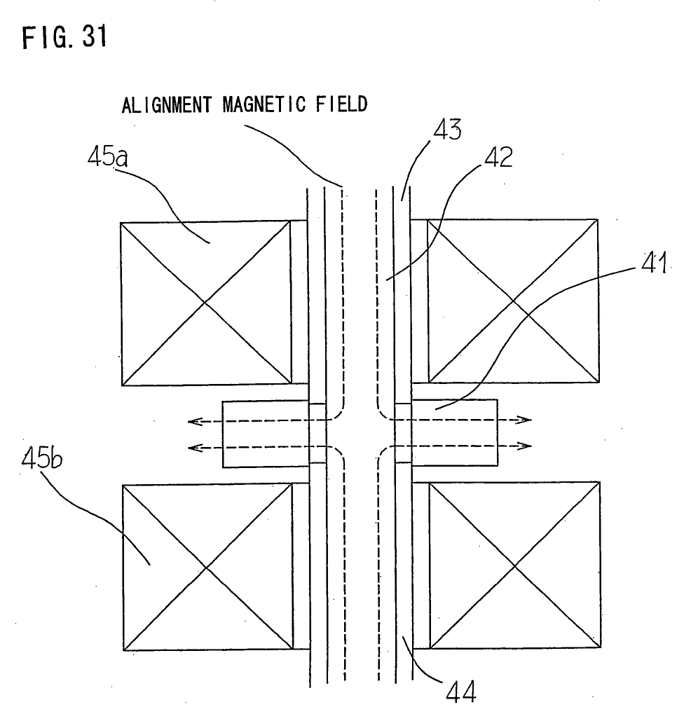

FIGS. 30A-30F are diagrams schematically showing a generally known pressing process for making a ring-shaped powder compact of a conventional radially-oriented ring magnet, and FIG. 31 is a diagram schematically showing a radially orienting magnetic field.

As illustrated in FIGS. 30A-30F, a metal die unit of a ring magnet manufacturing system for producing the ring-shaped powder compact of the conventional radially-oriented ring magnet includes a die 41 made of ferromagnetic material, a core 42 placed inside a curved inner surface of the die 41, and upper and lower punches 43, 44 made of nonmagnetic material. Referring to FIG. 31, the metal die unit includes a pair of upper and lower coils 45a, 45b for generating the radially orienting magnetic field. The upper coil 45a generates a magnetic field of which lines of magnetic flux are downward directed while the lower coil 45b generates a magnetic field of which lines of magnetic flux are upward directed. Both the upward- and downward-directed magnetic fluxes pass through the core 42 and are guided into a cavity 46. The magnetic fluxes pass through the cavity 46 and the die 41 in radial directions and return to the upper and lower coils 45a, 45b, recirculating through upper and lower looping paths. Under conditions where the radially orienting magnetic field passes through the cavity 46, magnetic powder 47 filled in the cavity 46 is compressed by the upper punch 43 or the lower punch 44 in an axial direction of the die 41, whereby a ring-shaped powder compact 48 is obtained.

Now, the conventional pressing process is explained with reference to FIGS. 30A-30F.
(1) The cavity 46 is formed by the die 41, the core 42 and the lower punch 44 as shown in FIG. 30A.
(2) The magnetic powder 47 is filled into the cavity 46 by an unillustrated powder feeder as shown in FIG. 30B.
(3) The upper punch 43 and an upper core section 43b descend and, with the cavity 46 closed, the radially orienting magnetic field is applied to the magnetic powder 47 as shown in FIG. 30C. At this time, the upper core section 43b and the core 42 are in contact with each other, together forming a magnetic path.
(4) As the upper punch 43 descends, the magnetic powder 47 in the cavity 46 is compressed in the axial direction of the die 41 as shown in FIG. 30D, whereby the ring-shaped powder compact 48 is formed.
(5) After pressurizing force exerted by the upper punch 43 is removed, the die 41 is lowered to release the ring-shaped powder compact 48 from the die 41 as shown in FIG. 30E.
(6) After the upper punch 43 has ascended as shown in FIG. 30F, the ring-shaped powder compact 48 is removed from the metal die unit.

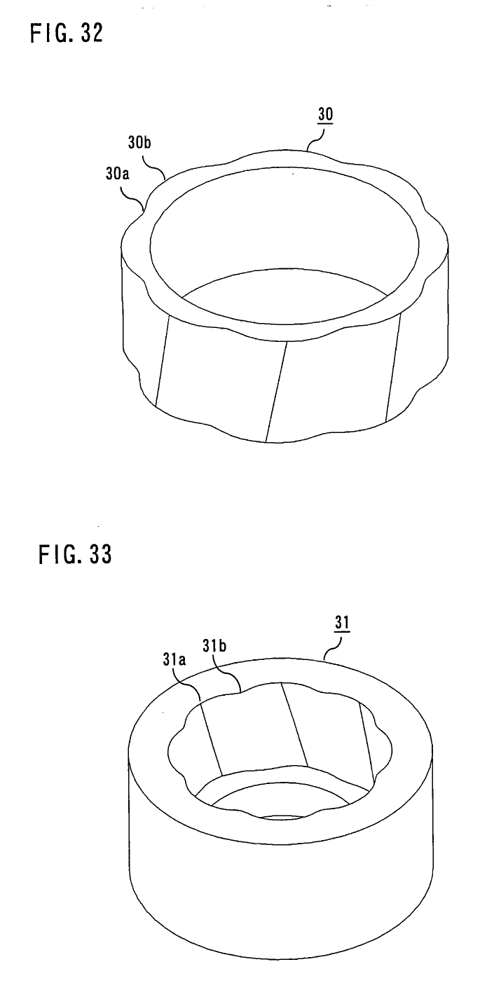

Although ring-shaped powder compacts having an unchanging cross-sectional shape along an axial direction thereof can be pressed by the above-described conventional pressing process, it is impossible to make ring-shaped powder compacts for manufacturing the aforementioned ring magnets of the preferred embodiments of the invention by the conventional pressing process and metal die unit, in which cross-sectional shape varies along the axial direction as shown in FIG. 32, for example, due to longitudinally skewed surface corrugations.

Reasons why the conventional pressing process and metal die unit can not be used for manufacturing the ring magnets of the invention are as follows. Referring again to FIGS. 30A-30F, the ring-shaped powder compact 48 is pressurized by the upper punch 43 during the pressing process so that the ring-shaped powder compact 48 is biased to radially expand due to a compressive stress remaining therein while the ring-shaped powder compact 48 is held in the die 41 even after the pressurizing force exerted by the upper punch 43 has been removed. Therefore, if one attempts to remove the ring-shaped powder compact 48 in the axial direction, a friction force acts between the ring-shaped powder compact 48 and the curved inner surface of the die 41. If the cross-sectional shape of the ring-shaped powder compact 48 remains the same along the axial direction, it would be possible to release the ring-shaped powder compact 48 from the die 41 by simply pushing the ring-shaped powder compact 48 in the axial direction. (In the example shown in FIGS. 30A-30F, the lower punch 44 is kept at a fixed position and the die 41 is pulled downward when releasing the ring-shaped powder compact 48.) If the cross-sectional shape of the ring-shaped powder compact varies along the axial direction, however, it is not possible to release the ring-shaped powder compact from the die 41 by simply pushing the ring-shaped powder compact in the axial direction.

FIG. 32 shows an example of a ring-shaped powder compact 30 produced by the first ring magnet manufacturing method. The ring-shaped powder compact 30 has corrugations (hollows 30a and protrusions 30b) formed on a generally cylindrical outer surface, the corrugations being skewed about an axial direction of the ring-shaped powder compact 30. Since the skew angle of the corrugations is uniform along the axial direction of the ring-shaped powder compact 30 in this example, it is possible to remove the ring-shaped powder compact 30 from a die by drawing the ring-shaped powder compact 30 while rotating it at a fixed rate from a geometrical point of view. In actuality, however, the ring-shaped powder compact 30 is not strong enough to withstand a friction force exerted by a curved inner surface of the die, so that the ring-shaped powder compact 30 would inevitably break if forcibly drawn against the friction force by such die release operation.

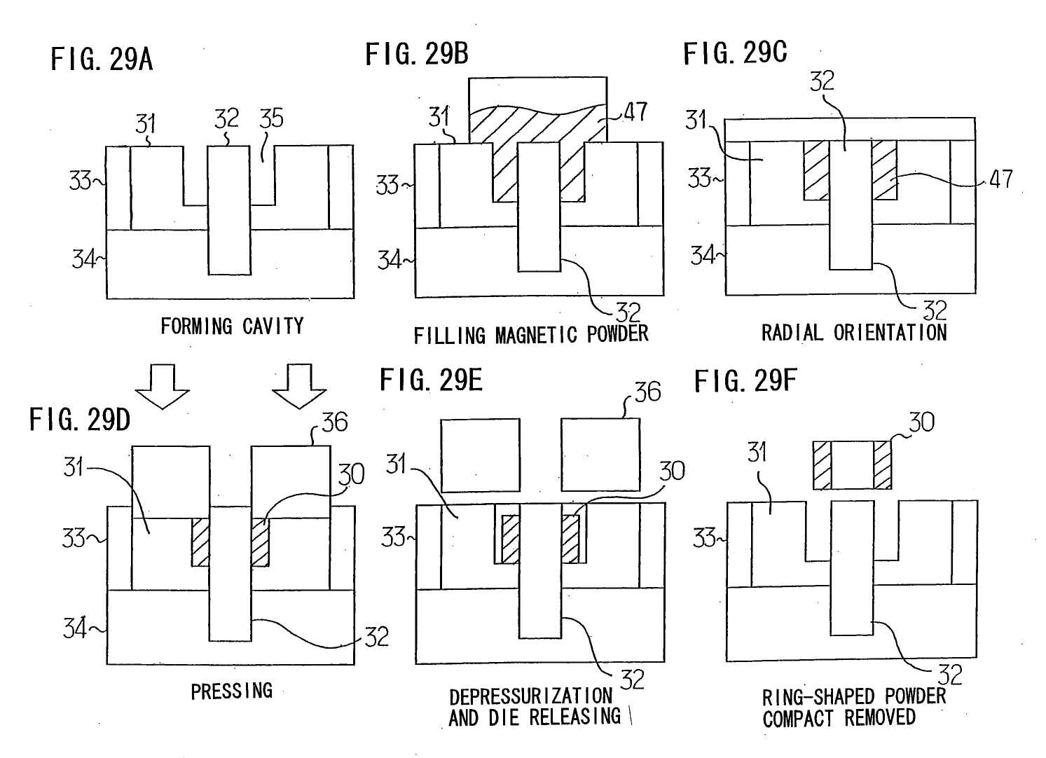

FIG. 33 is a perspective view of a ring-shaped die 31 used in the ring magnet pressing unit (metal die unit) in the first ring magnet manufacturing method, and FIGS. 29A-29F are diagrams schematically showing the pressing process performed by using the die 31 of FIG. 33.

As illustrated in FIGS. 29A-29F, the metal die unit of a ring magnet manufacturing system of the invention for producing a ring-shaped powder compact of the sintered ring magnet includes the ring-shaped die 31 made of elastic material, a core 32 made of ferromagnetic material placed inside a curved inner surface of the die 31, a ring-shaped member 33 made of ferromagnetic material placed outside a curved outer surface of the die 31, and a base 34 for mounting the die 31, the core 32 and the ring-shaped member 33. Magnetic powder 47 is filled in a cavity 35 surrounded by the curved inner surface of the die 31 and a curved outer surface of the core 32.

Referring to FIG. 33, the curved inner surface of the die 31 is corrugated with eight each hollows 31a and protrusions 31b alternately formed at regular angular intervals (45°) in a circumferential direction. These corrugations are inclined by a skew angle of 6.87° about an axial direction of the die 31. A generally cylindrical internal space of the die 31 has an axial length of 16.2 mm, a maximum inside diameter of 44 mm as measured between outermost points of any two opposite hollows 31a and a minimum inside diameter of 42 mm as measured between innermost points of any two opposite protrusions 31b, and the core 32 has an outside diameter of 33 mm. The difference in height between the outermost points of the hollows 31a and the innermost points of the protrusions 31b is 1 mm.

A punch 36 shown in FIG. 29D serves as a pressurizing part for pressurizing both the magnetic powder 47 filled in the cavity 35 and the die 31. The die 31 is made of silicone rubber in gel form and contains 40% to 70% by volume of iron powder, for instance, so that the die 31 can be used when applying a radially orienting magnetic field. The iron powder is uniformly dispersed within the volume of die 31.

Now, the pressing process for making the ring-shaped powder compact 30 according to the first ring magnet manufacturing method of the invention is explained with reference to FIGS. 29A-29F.
(1) The cavity 35 is formed by the die 31 and the core 32 as shown in FIG. 29A.
(2) The magnetic powder 47 is filled into the cavity 35 as shown in FIG. 29B so that a bulk density of 3 is attained.
(3) A radially orienting magnetic field is applied to the magnetic powder 47 in the cavity 35 as shown in FIG. 29C at a magnetic flux density of 3 tesla or more.
(4) The punch 36 made of nonmagnetic material pressurizes the magnetic powder 47 in the cavity 35 and the die 31 together in the axial direction as shown in FIG. 29D. Since the die 31 having elasticity is constrained on the curved outer surface by the ring-shaped member 33, the die 31 deforms as if expanding inward toward a central axis thereof. Thus, the magnetic powder 47 in the cavity 35 is pressed by pressurization axially downward by the punch 36 and radially inward by the die 31. Consequently, the magnetic powder 47 is formed into the ring-shaped powder compact 30 having a maximum outside diameter of 42.24 mm, an inside diameter of 33 mm and a height of 15.55 mm.
(5) Next, the punch 36 is lifted upward as shown in FIG. 29E. As a result, the die 31 which has been deformed inward toward the central axis due to radial pressurization returns to an original shape and a clearance is created between the curved outer surface of the ring-shaped powder compact 30 and the curved inner surface of the die 31. Since the maximum outside diameter of the ring-shaped powder compact 30 is 42.24 mm (as measured between any two opposite protrusions 30a) and the minimum inside diameter of the die 31 when not pressurized is 42 mm (as measured between innermost points of any two opposite protrusions 31b) as already mentioned, there is created a clearance of at least about 0.1 mm between the ring-shaped powder compact 30 and the die 31.
(6) The pressing process is completed by releasing the ring-shaped powder compact 30 from the die 31 as shown in FIG. 29F.

If three ring-shaped powder compacts 30 are produced by the aforementioned pressing process and stacked such that the outer contour of an end surface of one ring-shaped powder compact 30 matches the outer contour of a facing end surface of another ring-shaped powder compact 30, and sintered together at 1,080° C. and subjected to a heat treatment at 600° C., for example, a preliminary sintered ring magnet is obtained. Top and bottom end surfaces and a cylindrical inner surface of the preliminary sintered ring magnet are ground to obtain a finished sintered ring magnet. After grinding, the preliminary sintered ring magnet may be subjected to an anticorrosion surface treatment if necessary.

The sintered ring magnet thus produced is just like the sintered ring magnet 230 of the aforementioned ninth embodiment (FIG. 23). This sintered ring magnet is radially magnetized such that individual magnetic poles are located along ridges of protrusions formed on a generally cylindrical outer surface and, therefore, the sintered ring magnet can be used for producing a high-power motor with reduced cogging torque as previously discussed.

### Second Manufacturing Method

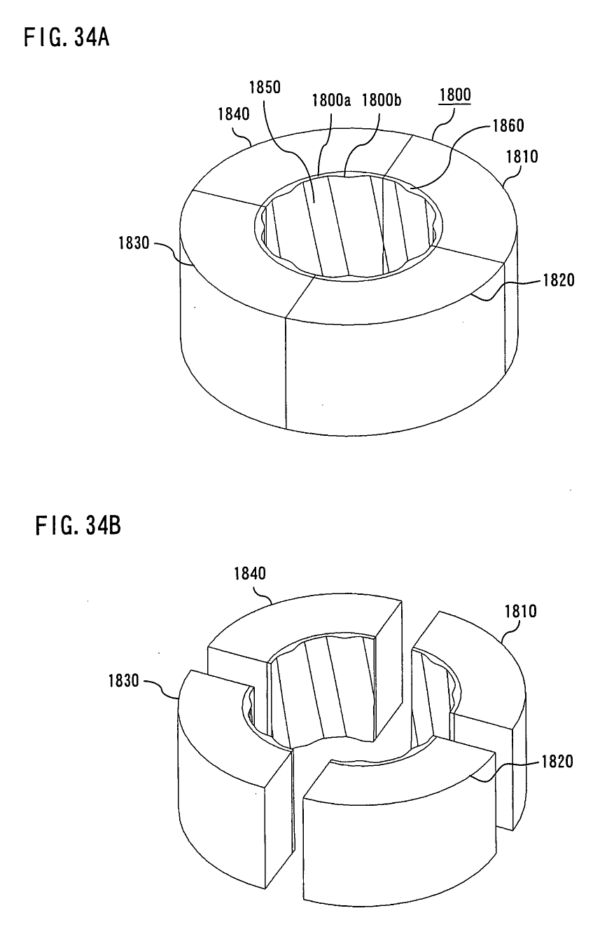

FIGS. 34A and 34B are perspective views of a die 1800 used in a ring magnet pressing unit (metal die unit) in a second method of manufacturing a sintered ring magnet. As shown in FIGS. 34A and 34B, the die 1800 used in the second ring magnet manufacturing method is made by combining four arch-shaped members 1810-1840 into a generally cylindrical form. Referring to FIG. 34A, in which the arch-shaped members 1810-1840 are combined, a curved inner surface of the die 1800 (which constitutes a curved outer surface of a cavity formed in the die 1800) is corrugated with eight each hollows 1800a and protrusions 1800b alternately formed at regular angular intervals (45°) in a circumferential direction. These corrugations are inclined by a skew angle of 6.9° about an axial direction of the die 1800. The die 1800 has an axial length of 26 mm, a maximum inside diameter of 43 mm as measured between outermost points of any two opposite hollows 1800a and a minimum inside diameter of 42 mm as measured between innermost points of any two opposite protrusions 1800b. A core (not shown) has an outside diameter of 33 mm. The difference in height between the outermost points of the hollows 1800a and the innermost points of the protrusions 1800b is 1 mm. As viewed along the axial direction of the die 1800, an outermost portion of each of the hollows 1800a forms part of a circle (or an arc segment 1850 in cross section) of which center lies on a central axis of a generally cylindrical inner surface of the die 1800.

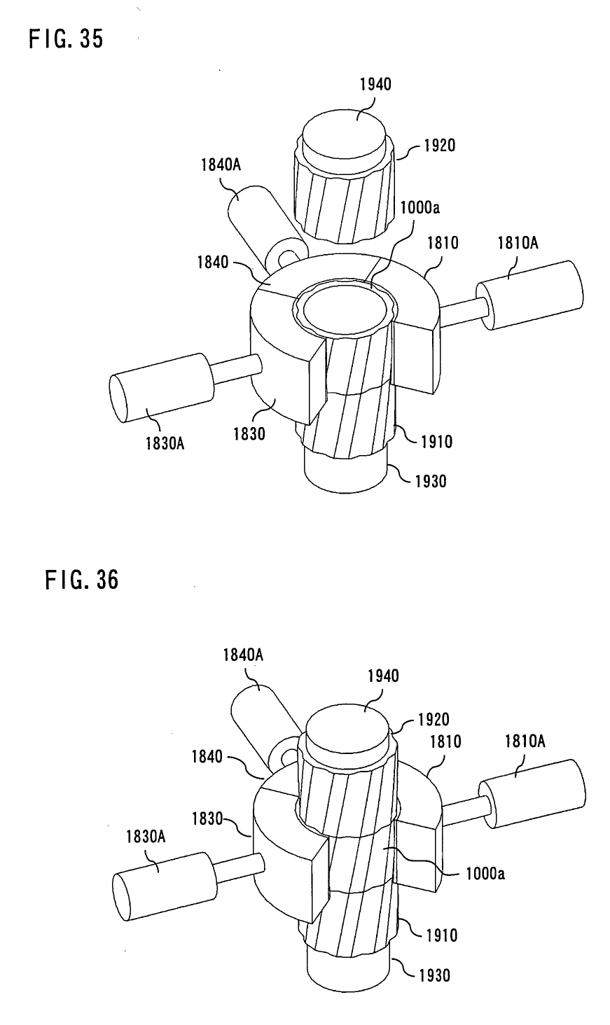

Now, a pressing process for making a ring-shaped powder compact according to the second ring magnet manufacturing method of the invention is explained. FIGS. 35-39 are perspective views schematically showing the pressing process for making the ring-shaped powder compact according to the second ring magnet manufacturing method. Among the four arch-shaped members 1810-1840 of the die 1800, the arch-shaped member 1820 is not shown in FIGS. 35-39 to facilitate understanding of statuses within the metal die unit.

Referring to FIG. 35, direct-acting mechanisms 1810A, 1820A, 1830A, 1840A driven by hydraulic cylinders are attached to curved outer surfaces of the arch-shaped members 1810, 1820, 1830, 1840 of the die 1800, respectively, so that the arch-shaped members 1810, 1820, 1830, 1840 can be moved in radial directions. The ring magnet pressing unit includes a lower punch 1910 and an upper punch 1920 of which curved outer surfaces are corrugated with protrusions and hollows which fit along the hollows 1800a and the protrusions 1800b formed on the curved inner surface of the die 1800. The corrugations (protrusions and hollows) on the curved outer surfaces of the lower and upper punches 1910, 1920 are separated from the corrugations (the hollows 1800a and the protrusions 1800b) on the curved inner surface of the die 1800 by a clearance of 0.01 to 0.04 mm. Although not illustrated, the upper punch 1920 is made movable along the axial direction by means of a motor and ball screw for pressurizing magnetic powder 1000a which will be filled into the cavity formed in the die 1800. Additionally, the upper punch 1920 is caused to rotate about its longitudinal axis by a servomotor at a rate corresponding to the skew angle of the corrugations formed on the curved inner surface of the die 1800 in synchronism with movement along the axial direction. In the second ring magnet manufacturing method of the invention, the upper punch 1920 is controlled to rotate 9.6° clockwise while the upper punch 1920 moves 26 mm downward in the axial direction. The upper punch 1920 is initially set at such an angular position that an inner contour of an upper end of the die 1800 aligns with an outer contour of a lower end of the upper punch 1920 when the lower end of the upper punch 1920 descends to the same level as the upper end of the die 1800.

The four arch-shaped members 1810, 1820, 1830, 1840 are forced toward the central axis by the direct-acting mechanisms 1810A, 1820A, 1830A, 1840A, respectively, so that the die 1800 is held in a ring form as shown in FIG. 34A. The aforementioned cavity is formed by the die 1800, a lower core section 1930 made of ferromagnetic material and the lower punch 1910 made of nonmagnetic material. Then, the magnetic powder 1000a is filled into the cavity by a powder feeder. FIG. 35 shows the status of the metal die unit at this point.

Next, the upper punch 1920 made of nonmagnetic material and an upper core section 1940 made of ferromagnetic material descend together as shown in FIG. 36 and, with the cavity closed, a radially orienting magnetic field is applied to the magnetic powder 1000a. At this point, the lower and upper cores 1930, 1940 are in mutual contact, together forming part of a magnetic path.

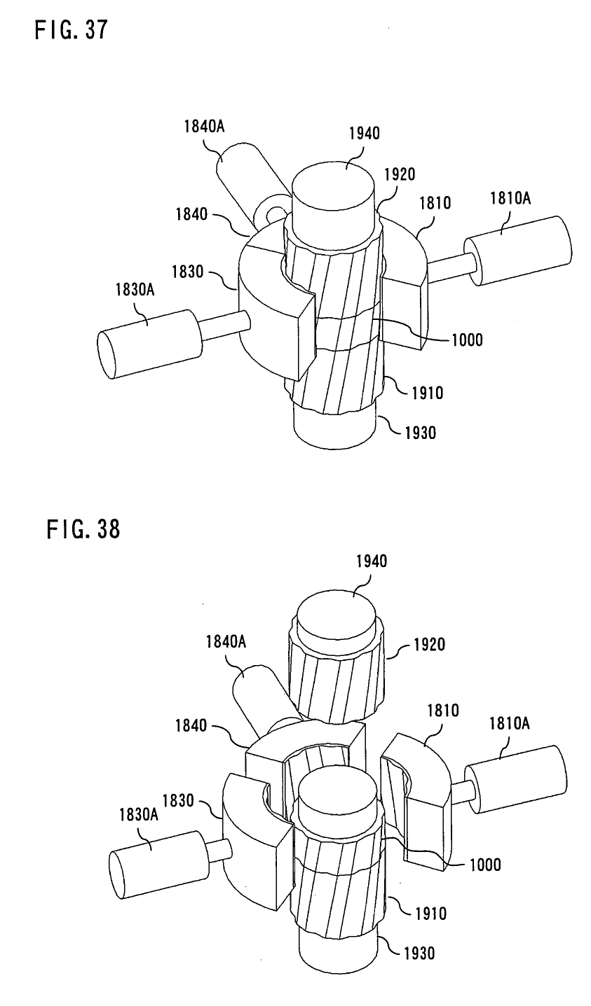

Next, the upper punch 1920 descends while turning at the rate corresponding to the skew angle of the corrugations on the die 1800, compressing thereby the magnetic powder 1000a filled in the cavity to form a ring-shaped powder compact 1000, as shown in FIG. 37. Here, the lower punch 1910 may be caused to ascend while turning at the same time. The ring-shaped powder compact 1000 can be formed with increased shape accuracy if the magnetic powder 1000a is compressed by both the lower and upper punches 1910, 1920. This is because the density of the ring-shaped powder compact 1000 becomes uniform if simultaneously compressed from both top and bottom.

Subsequently, the upper punch 1920 and the upper core section 1940 are raised while causing the upper punch 1920 to rotate about its longitudinal axis and the four arch-shaped members 1810, 1820, 1830, 1840 constituting the die 1800 are moved radially outward by the hydraulic cylinder-operated direct-acting mechanisms 1810A, 1820A, 1830A, 1840A as shown in FIG. 38. The arch-shaped members 1810, 1820, 1830, 1840 are to be moved by a distance larger than the difference in height between the outermost points of the hollows 1800a and the innermost points of the protrusions 1800b formed on the curved inner surface of the die 1800. As the arch-shaped members 1810, 1820, 1830, 1840 of the die 1800 are separated from a curved outer surface of the ring-shaped powder compact 1000 in this way, a compressive stress in the ring-shaped powder compact 1000 is uniformly released and, therefore, the ring-shaped powder compact 1000 would not easily break as a result of the die release operation.

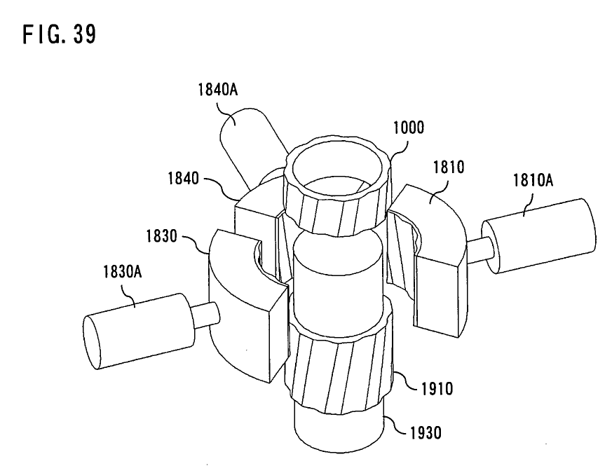

Finally, the ring-shaped powder compact 1000 is released from the lower core section 1930 as shown in FIG. 39, whereby the ring-shaped powder compact 1000 of which curved outer surface is corrugated with skewed protrusions and hollows is obtained. Because the compressive stress in the ring-shaped powder compact 1000 is released and the ring-shaped powder compact 1000 enlarges in diameter due to spring back when the arch-shaped members 1810, 1820, 1830, 1840 of the die 1800 are moved radially outward, there is created a clearance between the lower core section 1930 and the ring-shaped powder compact 1000. Furthermore, when the arch-shaped members 1810, 1820, 1830, 1840 of the die 1800 are moved radially outward, there is also created a clearance between outermost points of any protrusions of the ring-shaped powder compact 1000 and the innermost points of the protrusions 1800b of the die 1800, so that the ring-shaped powder compact 1000 can be easily released from the lower core section 1930.

If three ring-shaped powder compacts 100 are produced by the aforementioned pressing process and stacked such that the outer contour of an end surface of one ring-shaped powder compact 1000 matches the outer contour of a facing end surface of another ring-shaped powder compact 100, and sintered together at 1,080° C. and subjected to heat treatment at 600° C., for example, a preliminary sintered ring magnet is obtained. Top and bottom end surfaces and a cylindrical inner surface of the preliminary sintered ring magnet as well as an outermost portion of each of the protrusions forming part of a circle (or an arc segment in cross section) on the corrugated outer surface of the ring-shaped powder compacts 100 are ground to obtain a finished sintered ring magnet. After grinding, the preliminary sintered ring magnet may be subjected to an anticorrosion surface treatment if necessary.

The sintered ring magnet thus produced is just like the sintered ring magnet 240 of the aforementioned modified form of the ninth embodiment (FIG. 24). This sintered ring magnet is radially magnetized such that individual magnetic poles are formed along lines each of which connects circumferential midpoints of the outermost portion of the protrusion (arc segment in cross section) formed on a generally cylindrical outer surface and, therefore, the sintered ring magnet can be used for producing a high-power motor with reduced cogging torque as previously discussed.

In the aforementioned first ring magnet manufacturing method of the invention, a sintered ring magnet is produced by a manufacturing system for making a ring-shaped powder compact, the manufacturing system including a ring-shaped die having elasticity, a core placed inside a curved inner surface of the die, the die and the core together forming a cavity therebetween into which magnetic powder is filled, and a pressurizing part (punch) for pressurizing both the magnetic powder filled in the cavity and the die, wherein cross-sectional shapes of the ring-shaped powder compact taken by planes perpendicular to a central axis of the curved inner surface of the die vary from one position to next along the axial direction. The sintered ring magnet is produced through processes of magnetically orienting the magnetic powder by applying a magnetic field, pressing the magnetic powder and sintering the ring-shaped powder compact.

In the second ring magnet manufacturing method of the invention discussed above, a sintered ring magnet is produced by a manufacturing system for making a ring-shaped powder compact, the manufacturing system including a ring-shaped die formed by combining a plurality of arch-shaped members, a core placed inside a curved inner surface of the die, the die and the core together forming a cavity therebetween into which magnetic powder is filled, and a pressurizing part (punch) for pressurizing the magnetic powder filled in the cavity, wherein cross-sectional shapes of the ring-shaped powder compact taken by planes perpendicular to a central axis of the curved inner surface of the die vary from one position to next along the axial direction. The sintered ring magnet is produced through processes of magnetically orienting the magnetic powder by applying a magnetic field, pressing the magnetic powder and sintering the ring-shaped powder compact.

What is claimed is:

1. A sintered ring magnet produced through processes of magnetically orienting magnetic powder by applying a magnetic field, pressing the magnetic powder and sintering a ring-shaped powder compact thus formed, the sintered ring magnet having a generally cylindrical outer surface with surface corrugations formed by alternating hollows and protrusions at regular intervals around the sintered ring magnet at least in part along an axial direction thereof, wherein the sintered ring magnet varies in cross-sectional shape from one position to next along the axial direction, and magnetic poles are formed along said surface corrugations with boundaries of the magnetic poles located in the hollows.

2. A sintered ring magnet according to claim 1, wherein the hollows and the protrusions are skewed about a longitudinal axis of the sintered ring magnet.

3. A sintered ring magnet according to claim 1, wherein said surface corrugations are shaped into a wavy pattern expressed approximately by absolute values of a sine wave.

4. A sintered ring magnet according to claim 1, wherein, as viewed in cross section perpendicular to the longitudinal axis of the sintered ring magnet, outermost portions of the protrusions form arc segments constituting part of a circle of which center lies on the longitudinal axis of the sintered ring magnet.

5. A sintered ring magnet according to claim 1, wherein, as viewed in cross section perpendicular to the longitudinal axis of the sintered ring magnet, all of the protrusions form arc segments constituting part of a circle of which center lies on the longitudinal axis of the sintered ring magnet.

6. A sintered ring magnet according to claim 5, wherein there are formed rounded corners along boundaries between each of the arc segments formed on the protrusions constituting part of a circle and the adjacent hollows.

7. A sintered ring magnet according to claim 5, wherein the arc segments formed on the protrusions are shaped to a dimensional accuracy equal to or less than ⅕ of the difference in height between the protrusions and a stator with which the sintered ring magnet is positioned face to face when fitted in a motor.

8. A sintered ring magnet according to claim 1, wherein each of the hollows varies in cross-sectional shape from one position to next along the axial direction of the sintered ring magnet, the width or depth of each of the hollows continuously varying along the axial direction of the sintered ring magnet.

9. A sintered ring magnet according to claim 8, wherein the cross-sectional shapes of the hollows vary symmetrically with respect to a plane cutting through the sintered ring magnet at right angles to the longitudinal axis of the sintered ring magnet at a mid-length position thereof.

10. A sintered ring magnet according to claim 8, wherein a line passing through midpoints of the circumferential width of each of the hollows is skewed along the axial direction of the sintered ring magnet.

11. A sintered ring magnet according to claim 1, wherein both axial ends of the sintered ring magnet has a circle-shaped outer periphery as viewed along the axial direction.

12. A sintered ring magnet according to claim 1, wherein a line passing through midpoints of the circumferential width of each of the hollows is skewed along the axial direction of the sintered ring magnet, and skew angle of the line passing through the midpoints of the circumferential width of each of the hollows becomes smaller toward both axial ends of the sintered ring magnet.

13. A sintered ring magnet formed by stacking a plurality of sintered ring magnets of claims 1 along the axial direction.

14. A sintered ring magnet according to claim 13 wherein a plurality of sintered ring magnets are stacked along the axial direction in such a fashion that outer contours of facing end surfaces of any two adjacent sintered ring magnets match up with each another.

15. A sintered ring magnet according to claim 13, wherein a plurality of sintered ring magnets are stacked along the axial direction with a specific layer-to-layer angular displacement so that outer contours of facing end surfaces of any two adjacent sintered ring magnets do not match up with each another.

16. A sintered ring magnet according to claim 13 formed by stacking a plurality of sintered ring magnets along the axial direction, wherein each of the stacked sintered ring magnets is configured in such a fashion that each of the hollows varies in cross-sectional shape from one position to next along the axial direction and a line passing through midpoints of the circumferential width of each of the hollows is skewed along the axial direction, and wherein the lines passing through the midpoints of the circumferential width of each of the hollows formed in any two adjacent sintered ring magnets are skewed in opposite circumferential directions.
